(19) United States
(12) Patent Application Publication
(10) Pub. No.: US 2017/0043609 A1
(43) Pub. Date: Feb. 16, 2017

(54) SECURITY DEVICE COMPONENTS AND METHODS OF MANUFACTURE THEREOF

(71) Applicant: DE LA RUE INTERNATIONAL LIMITED, Basingstoke, Hampshire (GB)

(72) Inventor: Adam LISTER, Andover (GB)

(73) Assignee: DE LA RUE INTERNATIONAL LIMITED, Basingstoke, Hampshire (GB)

(21) Appl. No.: 15/305,526

(22) PCT Filed: Apr. 23, 2015
(86) PCT No.: PCT/GB2015/051202

§ 371 Date: Oct. 20, 2016

(30) Foreign Application Priority Data
Apr. 30, 2014 (GB) 1407592.3

(51) Int. Cl. B42D 25/378; B42D 25/328; B42D 25/342; B42D 25/351; B42D 25/355; B42D 25/369; B42D 25/41; B42D 25/42; B42D 25/455; B42D 25/46; B42D 25/21; B42D 25/337; B42D 25/364; B41M 3/14; G03C 5/08; B42D 25/324

(52) U.S. Cl. CPC B42D 25/378; B42D 25/324; B42D 25/328; B42D 25/342; B42D 25/351; B42D 25/355; B42D 25/369; B42D 25/41; B42D 25/42; B42D 25/455; B42D 25/46; B42D 25/21; B42D 25/337; B42D 25/364; B41M 3/142; G03C 5/08

(57) ABSTRACT

A method of manufacturing a security device component includes: providing a photosensitive film including a diazonium compound which decomposes upon exposure to radiation of a predetermined wavelength; providing a dye coupler film comprising one or more dye coupler compositions; exposing elements of the photosensitive film to radiation of the predetermined wavelength in accordance with a predetermined pattern; and contacting at least part of the exposed photosensitive film against at least part of the dye coupler film so as to effect at least partial transfer of the one or more dye coupler compositions to the exposed photosensitive film, whereupon unexposed elements of the photosensitive film exhibit one or more colours such that the photosensitive film exhibits a reproduction of the predetermined pattern.

The present invention relates to components of security devices as may be used for example to confirm the authenticity of objects or documents of value, such as banknotes and the like, and methods of their manufacture.

Objects of value, and particularly documents of value such as banknotes, cheques, passports, identification documents, certificates and licenses, are frequently the target of counterfeiters and persons wishing to make fraudulent copies thereof and/or changes to any data contained therein. Typically such objects are provided with a number of visible security devices for checking the authenticity of the object. Examples include printed features, such as microtext, fine line patterns and latent images where the security effect can be exhibited by a single layer of pattern elements; as well as more complex structures such as venetian blind devices, lenticular devices, moiré interference devices and moiré magnification devices, where interaction between two or more layers produces the secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

There is a constant need to improve the security level of security devices to stay ahead of potential counterfeiters. In order for a security device to be most effective, it must be readily distinguishable from copies or imitations and in the case of a visible security device this requires the device to exhibit a distinctive visual effect which is easily tested. Many of the known types of security device mentioned above depend for this effect upon the high resolution with which pattern elements of the device have been produced. For instance, microtext and fine line features rely on their elements having a higher resolution than is achievable using printing techniques available to would-be counterfeiters. Further, the varying appearance of latent images, venetian blind devices, lenticular devices, moiré interference devices and moiré magnification devices at different angles of view depend at least in part upon the closeness with which the pattern elements comprised in the device can be laterally placed. This is discussed in detail in our International Patent Application No. PCT/GB2012/052520.

Typical printing processes used to manufacture pattern elements for security devices include intaglio, gravure, wet lithographic printing and dry lithographic printing. The achievable resolution is limited by several factors, including the viscosity, wettability and chemistry of the ink, as well as the surface energy, unevenness and wicking ability of the substrate, all of which lead to ink spreading. With careful design and implementation, such techniques can be used to print pattern elements with a line width of between 25 μm and 50 μm. For example, with gravure or wet lithographic printing it is possible to achieve line widths down to about 15 μm. However, consistent results at this resolution are difficult to achieve and in any case this level of resolution still imposes a significant limitation on the security device. Higher resolution elements (i.e. smaller line widths) would be highly desirable.

One approach which has been put forward as an alternative to the printing techniques mentioned above is used in the so-called Unison Motion™ product by Nanoventions Holdings LLC, as mentioned for example in WO-A-2005052650. This involves creating pattern elements (“icon elements”) as recesses in a substrate surface before spreading ink over the surface and then scraping off excess ink with a doctor blade. The resulting inked recesses can be produced with line widths of the order of 2 μm to 3 μm. This high resolution produces a very good visual effect, but the process is complex and expensive. Further, limits are placed on the minimum substrate thickness by the requirement to carry recesses in its surface. In addition, the method is only suitable for producing patterns of a single colour.

In our International Patent Application No. PCT/GB2012/052520, the use of vesicular photosensitive film was proposed for producing high resolution patterns based on photographic reproduction of a master. This has been found well suited for the formation of fine elements of 5 micron line width or less. However, the colour options are limited by the available vesicular films. It would be desirable to achieve similarly high resolution elements with less limitation as to their colour.

The use of diazo-based chemistry for photographic reproduction is known from WO-A-83/00750 for example. This involves providing a film containing a suitable diazonium salt and exposing it to actinic (UV) light through a patterned master film, which causes decomposition of the diazonium salt to form unreactive species. The exposed film is then developed by immersion into an alkaline solution containing species known as “couplers” to form a coloured dye-like compound in the unexposed portions of the film, resulting in a reproduction of the original master pattern. The colour of the reproduced image will depend on the choice of diazonium salt and coupler. However, the development process poses practical difficulties due to the need to immerse the film in the coupler solution, and the colour options are still limited.

In accordance with a first aspect of the present invention, a method of manufacturing a security device component is provided, comprising:
providing a photosensitive film comprising a diazonium compound which decomposes upon exposure to radiation of a predetermined wavelength;
providing a dye coupler film comprising one or more dye coupler compositions;
exposing elements of the photosensitive film to radiation of the predetermined wavelength in accordance with a predetermined pattern;
contacting at least part of the exposed photosensitive film against at least part of the dye coupler film so as to effect at least partial transfer of the one or more dye coupler compositions to the exposed photosensitive film, whereupon unexposed elements of the photosensitive film exhibit one or more colours such that the photosensitive film exhibits a reproduction of the predetermined pattern.

By providing the dye coupler composition in the form of a film and arranging for it to diffuse into the exposed photosensitive film in this way, the manufacturing process is considerably simplified since there is no “wet” chemistry involved. The dye coupler film can be manufactured in a separate process (potentially by a different entity) and stored dry until needed. Since the dye coupler film is not photosensitive, no special storage conditions are required. The method is particularly well suited to implementation as a continuous, web-based process since the dye coupler film can be contacted against the exposed photosensitive film using readily available web-processing equipment such as a lamination nip. In addition, once the pattern has been developed, the film is dry and ready for use or storage with no washing steps required (as is typically the case in conventional methods). An additional benefit is an improvement in resolution of the reproduced pattern since there is no significant swelling/expansion of the photosensitive film (leading to an increase in the size of the pattern elements), as may otherwise be encountered upon the introduction of a wet solvent.

The finished product is a visible pattern, the resolution of which will typically closely match that of the original predetermined pattern. This can be used either as a security device on its own (e.g. microtext or fine-line patterns) or in combination with other components (e.g. lens arrays) to form security devices such as moiré magnifiers and lenticular devices.

It should be noted that, in the exposed pattern elements, the diazonium compound need not be entirely decomposed by the exposure, although this is preferred. Also, it is not essential that the unexposed pattern elements receive zero radiation of the predetermined wavelength provided that the dosage of radiation they receive is less than that received by the exposed pattern elements. For example, if the exposure takes place via a mask, the portions of the mask used to block the radiation from the unexposed pattern elements need not be 100% opaque to the relevant wavelength (but must block a greater proportion of the wavelength than the intervening portions defining the exposed pattern elements). Thus, the term “unexposed pattern elements” refers to those elements which receive less radiation of the predetermined wavelength than the exposed pattern elements (or none).

By “security device” we mean a feature which it is not possible to reproduce accurately by taking a visible light copy, e.g. through the use of standardly available photocopying or scanning equipment. Most preferably, the security device exhibits an optically variable effect, meaning that its appearance is different at different viewing angles. Depending on the nature of the selected visual effect, the predetermined pattern exhibited by the photosensitive film may by itself constitute a security device. For instance, the predetermined pattern may comprise microtext or may form a latent image. In other examples, the exposed photosensitive film may go on to be combined with another component, such as a second pattern, a viewing mask or a focussing element, to form the complete security device from which the desired visual effect is visible.

The diazoium compound will typically be a diazonium salt, of which examples will be provided below. Any of the diazo-containing substances conventionally used in diazo-based reproduction techniques could be utilised for this purpose (see for example WO-A-83/00750, U.S. Pat. No. 2,537,919 and U.S. Pat. No. 3,000,298). Typically the diazonium compound will be carried in a binder, such as a resin, to form the film.

As mentioned above, the term “dye coupler” refers to a substance which is capable of reacting with the (unexposed) diazonium compound in the photosensitive film to form a dye, typically an azo dye (i.e. a dye containing at least one azo group, —N═N—, where N stands for nitrogen). Again, such dye couplers are known and any of the examples in the documents mentioned above could be utilised. Typically, the dye coupler will be dispersed in a binder such as a resin to form the dye coupler film.

It should be noted that the dye coupler film need not be continuous or of uniform composition. For instance, the dye coupler film could have gaps or regions where the dye coupler itself is not present, such that the photosensitive film is not developed all-over by contact with the dye coupler film. Alternatively or additionally, as discussed further below, the dye coupler film could carry areas of different dye coupler compositions.

Depending on the diazoium compound, dye coupler composition(s) and binder systems selected, transfer of the dye coupler to the photosensitive film may solely require contact of the two films against one another. However, diffusion of the dye coupler into the photosensitive film may preferably be increased though the application of pressure and/or heat during all or part of the contact. Hence in some preferred examples, contacting the exposed photosensitive film against the dye coupler film comprises applying a pressure urging the exposed photosensitive film against the dye coupler film, the pressure preferably being in the range 80 to 4000 grams/linear cm. This can be achieved for example by using a nip between two rollers to bring the films into contact and apply a pressure. The method may additionally or alternatively comprise (before, during or after applying any pressure) heating the exposed photosensitive film and/or the dye coupler film during the contact between the films, preferably to a temperature in the range 75 to 140 degrees C., more preferably in the range 90 to 130 degrees C., most preferably around 100 degrees C. It should be noted that, in practice, the heat source could be located before the point at which the films make contact provided the desired temperature is retained by the films when they contact one another.

Preferably, the diffusion of the coupler dye into the photosensitive film is higher than the diffusion of the diazonium compound at the conditions under which contact takes place. This is desirable in order to limit lateral diffusion of the diazo compound, which would lead to a loss in resolution, whilst enabling sufficient transfer of the dye coupler to achieve development of the visible pattern. This can be achieved through careful selection of the diazo, dye coupler and binder systems, as well as the contact parameters (e.g. temperature and pressure). Examples of suitable implementations are given below.

The required duration of contact between the two films will again depend on the diazo, dye coupler and binder systems as well as the contact conditions, but in preferred examples, the contact between the exposed photosensitive film and the dye coupler film has a duration between about 1 and 10 seconds

Contact between the two films can be achieved in various ways, including inserting the two films into a press as may be particularly suitable for batch or sheet processing. However in particularly preferred examples, the contacting is performed by conveying the exposed photosensitive film and the dye coupler film through a nip formed between two rollers, preferably a heated nip. This enables the film to be developed in a continuous, web-based process if desired.

Depending on the make-up of the dye coupler composition, and particularly any binder in which the dye coupler is dispersed, the dye coupler film could comprise solely a self-supporting layer of the dye coupler composition. However, in preferred examples, the dye coupler film comprises a dye coupler carrier substrate on which the dye coupler composition is disposed, the dye coupler carrier substrate preferably being at least semi-transparent. For example, the carrier substrate may be a polymer film, such as PET, and may be treated to improve adhesion, e.g. corona treated.

As mentioned above, the manufacture of the dye coupler film may be carried out separately from the exposure/development process (e.g. on a separate processing line, and possibly by a different entity or at a different site), since the film can then be stored, potentially for a long period of time, before use in developing an exposed photosensitive film. However, in some implementations, the processes could be combined and hence the method may further comprise forming the dye coupler film by applying the one or more dye coupler compositions to the dye coupler carrier substrate, preferably by printing or coating the one or more dye coupler compositions onto the dye coupler carrier substrate, optionally in-line with the exposure/contact steps. Performing the steps in-line has some benefits including better control of the colour contrast in the final product. This could be achieved for example by gravure printing, flexographic printing, lithographic printing or screen printing. Digital printing techniques such as ink jet are also feasible. In this case, preferably the method further comprises drying the dye coupler film prior to contact between the dye coupler film and the exposed photosensitive film. Particularly where the dye coupler film includes gaps or regions of different compositions (discussed below) this helps to avoid any smudging of the dye coupler composition(s) upon contact with the photosensitive film, and makes the dye coupler film easier to handle. Where the production of the dye coupler film is carried out in combination with the exposure/development process, preferably the steps of applying the one or more dye coupler compositions to the dye coupler carrier substrate and contacting the dye coupler film against the exposed photosensitive film are performed in a continuous, in-line process. This can be used for example to attain register between any distinct regions of the dye coupler film and the exposed pattern on the photosensitive film, if desired.

Similarly, whether or not the method includes the formation of the dye coupler film, it is preferred that the steps of exposing the photosensitive film and contacting the dye coupler film against the exposed photosensitive film are performed in a continuous, in-line process.

After development of the visible pattern on the photosensitive film, the dye coupler film (including any dye coupler carrier substrate) could be retained in position, such that the reproduced pattern is “sandwiched” between the dye coupler film and the photosensitive film. This may be beneficial in terms of protecting the pattern during handling. However, this will also increase the thickness of the finished product and therefore, preferably, the method further comprises separating the dye coupler film and any dye coupler carrier substrate, if present, from the exposed photosensitive film after the at least partial transfer of dye coupler has taken place.

As already alluded to, the dye coupler film may include regions of different composition, with the result that different portions of the exposed photosensitive film will be brought into contact with different dye couplers. This reveals a particular strength of the present method since, due to the “dry” nature of the technique, the boundaries between such regions will be clearly defined as compared with comparable “wet” processes (discussed below). Hence in a particularly preferred embodiment, the dye coupler film comprises a first dye coupler composition in a first area of the dye coupler film and a second dye coupler composition, different from the first, in a second area of the dye coupler film which is different from the first area, such that, after contact between the dye coupler film and the exposed photosensitive film, unexposed elements of the photosensitive film in a first area exhibit a first colour and unexposed elements of the photosensitive film in a second area exhibit a second colour, the first and second areas of the photosensitive film corresponding to the first and second areas of the dye coupler layer, whereby the photosensitive film exhibits a multi-coloured reproduction of the predetermined pattern. The achievement of a multi-coloured pattern (which has not previously been possible, using conventional techniques) significantly increases the visual impact of the resulting security device and also raises the difficulty of counterfeiting substantially. Three or more colours could be provided in a corresponding manner by providing additional dye coupler compositions on the film in respective areas. This technique has then advantage that complex arrangements of colours can be achieved, limited only by the abilities of the process selected for formation of the dye coupler film. If the dye coupler compositions are printed or coated onto the film, the design freedom is very wide indeed.

A multi-coloured result can also be achieved using an alternative implementation of the method wherein two or more dye coupler films are provided, of which a first dye coupler film comprises at least a first dye coupler composition and a second dye coupler film comprises at least a second dye coupler composition, and simultaneously or sequentially, a first area of the exposed photosensitive film is contacted with the first dye coupler film and a second area of the exposed photosensitive film is contacted with the second dye coupler film, such that unexposed elements of the photosensitive film in the first area exhibit a first colour and unexposed elements of the photosensitive film in the second area exhibit a second colour, whereby the photosensitive film exhibits a multi-coloured reproduction of the predetermined pattern. One or both of the dye coupler films could include gaps in the coverage of their dye coupler composition(s) such that the photosensitive film is not developed all-over, with the other dye coupler film “filling in” all or part of the undeveloped portions to achieve the multi-coloured effect. Alternatively, one or both of the dye coupler films could be moved into and out of contact with the photosensitive film such that contact is only made with selected portions thereof. Three or more such dye coupler films could be utilised to form further colours if desired. An advantage of this technique over applying multiple dye couplers to one film is that there is no contact between dye couplers prior to drying (thereby avoiding smudging) and each dye coupler film can be supplied as a standard consumable, with the ultimate pattern of coloured areas on the photosensitive film determined only by the manner in which it is brought into contact with the dye coupler films.

In accordance with a second aspect of the invention, a method of manufacturing a security device component is provided, comprising:
providing a photosensitive film comprising a diazonium compound which decomposes upon exposure to radiation of a predetermined wavelength;
exposing elements of the photosensitive film to radiation of the predetermined wavelength in accordance with a predetermined pattern, then:
applying a first dye coupler composition to a first area of the photosensitive film, whereupon unexposed elements of the photosensitive film in the first area exhibit a first colour; and, simultaneously or sequentially:
applying a second dye coupler composition, different from the first, to a second area of the photosensitive film which is different from the first area, whereupon unexposed elements of the photosensitive film in the second area exhibit a second colour, different from the first colour;
such that the photosensitive film exhibits a multi-coloured reproduction of the predetermined pattern.

By applying different dye coupler compositions to different areas of the photosensitive film in this way, a multi-coloured result is achieved which as noted above has not been possible using conventional techniques. This gives rise to a new visual appearance which is particularly difficult to counterfeit and also substantially increases the design freedom of a security device incorporating a pattern manufactured in this way. It should be appreciated that this method can be implemented using the method discussed with respect to the first aspect of the invention, but is not limited to this.

Preferably, the first and second dye coupler compositions are applied to the photosensitive film in register with one another. This can be achieved for example by applying both simultaneously or in an inline process.

In one particularly preferred implementation, the first and second dye coupler compositions are applied to the photosensitive film by printing or coating each dye coupler composition onto the photosensitive film. This enables particularly high design freedom, especially if the printing or coating technique is digitally-controlled (i.e. does not involve formation of a “master”), since the arrangement of different coloured areas can be changed “on the fly” and can be used, for example, to individualise different portions of the photosensitive thread, e.g. by the introduction of personalisation information, at little expense in terms of cost or time. Suitable digital printing techniques include ink jet, laser jet, and dye diffusion thermal transfer (“D2T2”). However, in other implementations, printing techniques such as gravure, lithographic, flexographic, screen printing or intaglio will be better suited, e.g. for the formation of detailed patterns.

Such methods preferably further comprise washing any excess dye coupler composition off the photosensitive film, advantageously with an acidic washing solution. Preferably, washing takes place between the different dye coupler application steps so that any unreacted dye coupler is removed from the surface between each colour-making process, to avoid contamination. As discussed below, the dye coupler compositions typically contain an alkaline (base) component and the use of an acidic wash acts to neutralise any remaining alkali.

In other preferred implementations, the dye couplers can be applied to the photosensitive film using the method of the first aspect of the invention. As already discussed, this method is particularly well suited to the application of more than one dye coupler since the dry nature of the application technique avoids blurring at the boundaries between one region and the next. Hence, in one advantageous embodiment, the first and second dye coupler compositions are applied to the photosensitive film by:
providing a dye coupler film comprising a first dye coupler composition in a first area of the dye coupler film and a second dye coupler composition, different from the first, in a second area of the dye coupler film which is different from the first area, the first and second areas of the dye coupler layer corresponding to the first and second areas of the photosensitive film; and
contacting the exposed photosensitive film against the dye coupler film so as to effect at least partial transfer of the first and second dye coupler compositions to the respective areas of the exposed photosensitive film.

Alternatively or additionally it may be desirable to apply dye couplers from more than one dye coupler film (each of which may or may not carry multiple different dye couplers). Hence, preferably the first and second dye coupler compositions are applied to the photosensitive film by:
providing a first dye coupler film comprising a first dye coupler composition and a second dye coupler film comprising a second dye coupler composition, different from the first; and
contacting the first area of the exposed photosensitive film against the first dye coupler film and the second area of the exposed photosensitive film against the second dye coupler film so as to effect at least partial transfer of the first and second dye coupler compositions to the respective areas of the exposed photosensitive film.

Referring now to both the first and second aspects of the invention, preferably the first and second areas are laterally offset from one another, i.e. the first and second colours are ultimately visible alongside one another. The first and second areas may abut one another, or be spaced from one another, or may partially or fully overlap one another. Where the first and second areas fully overlap one another, the first area will be located wholly within the second area or vice versa (such that a part of the first or second area will not overlap the other) in order that two different colours remain visible. In this case, one of the first and second colours results from the first and second dye coupler compositions in combination (i.e. the colour in the area of overlap). Where the dye couplers are applied from one or more dye coupler films using the method of the first aspect of the invention the degree to which a “combined” colour of this sort will be formed will depend on the relative ability of each dye coupler to diffuse from the dye coupler film to the photosensitive film and, if both dye couplers are provided on one film, also on the thickness of the overlap of one dye coupler on the other on the dye coupler film. Where the dye couplers are applied sequentially, e.g. by printing, the relative quantities of dye coupler may need to be adjusted to ensure that there is a sufficient amount of (unreacted) diazonium compound still available for the second dye coupler to react with.

Where the first and second areas partially overlap one another (such that a part of the first area and a part of the second area is not overlapped with the other area), the unexposed elements of the photosensitive film in the area of overlap may preferably exhibit a further colour resulting from the first and second dye coupler compositions in combination. In this way additional colours can be introduced to the pattern without the need for further dye couplers. Again, the same considerations as to the ability of both dye couplers to react in the overlapping part as discussed above apply.

Any number of different dye couplers could be applied to respective areas of the photosensitive film in order to increase the complexity of the finished pattern. Thus, the method preferably further comprises applying a third and optionally further dye coupler compositions, each different from the first and second dye coupler compositions, to a respective area of the photosensitive film which is different from the first and second areas, whereupon unexposed elements of the photosensitive film in each respective area exhibit a different colour. The different dye couplers could each be applied sequentially, or some or all of them could be applied simultaneously.

As already discussed, one of the main benefits of the photographic reproduction technique is the ability to form pattern elements of very high resolution, e.g. less than 5 microns line width. Typically such elements are not visible to the unaided eye, requiring magnification in order to be viewed. In contrast it is desirable for the multi-coloured nature of the pattern to be readily apparent to the viewer and the areas of different colour are therefore preferably on a larger scale than that of the pattern elements arising from the exposure of the photosensitive film. Hence, advantageously, each area encompasses a plurality of the unexposed pattern elements. For example, each area may have dimensions of at least 100 microns, preferably at least 0.5 mm, more preferably at least 1 mm, in at least one direction, preferably in two orthogonal directions. Even larger areas will often be desirable, e.g. of several mm or even cm in each direction.

The two or more areas of different colour could take any arrangement on the film but in preferred examples, the areas define a second predetermined pattern, advantageously defining images, symbols or alphanumeric characters or a pattern of stripes, lines or tessellating shapes, most preferably fine-line patterns, filigree or guilloche patterns. Repeating patterns are particularly desirable. Thus advantageously, the second predetermined pattern is periodic and preferably has a periodicity of at least 1 mm, more preferably at least 5 mm, still preferably at least 10 mm. Again the pattern is preferably sufficiently large to be apparent to the unaided eye.

The method could be implemented as a sheet- or batch-fed process in which discrete units of photosensitive film are processed one by one. However, more preferably, the method is a web-based, continuous production method, comprising conveying the photosensitive film along a transport path, in order to achieve high throughput rates. In this case, the areas of different colour are preferably laterally offset from one another in the direction parallel to the transport path and/or in the direction perpendicular to the transport path. Again, overlapping is possible as discussed above.

Whilst not essential, in some preferred embodiments, the areas are registered to the exposed predetermined pattern on the photosensitive film. This further increases the difficulty of counterfeiting and can be achieved for example by carrying out the exposure of the photosensitive film and the application of the dye couplers to the film in a continuous, in-line process.

Each dye coupler composition may comprise only a dye coupler (or a combination of two or more dye couplers), or may additionally comprise a binder such as a resin, and in preferred embodiments each dye coupler composition may also include an alkaline (base) substance. Depending on the selected chemistry, an alkali may be required to facilitate or promote the reaction forming the dye compound.

Exposing the photosensitive film to the radiation in accordance with the predetermined pattern can be achieved in a number of ways. For example, a laser or other light beam of the predetermined wavelength could be directed across the film and modulated as necessary to produce the pattern. However, in preferred implementations, the photosensitive film is exposed to radiation of the predetermined wavelength through a mask. The mask comprises elements which are substantially opaque to radiation of the predetermined wavelength (or at least are more opaque to that radiation) and elements which are at least semi-transparent to radiation of the predetermined wavelength (or at least are less opaque to that radiation), arranged in accordance with the predetermined pattern. For example, the mask could comprise a metallised pattern carried on a transparent substrate.

Where the method is implemented as a web-based, continuous production method, and the photosensitive film is conveyed along a transport path, during the exposure of the photosensitive film, the mask is moved alongside the substrate web along at least a portion of the transport path at substantially the same speed as the photosensitive film, such that there is substantially no relative movement between the mask and the photosensitive film. This could be achieved for example by mounting the mask pattern on the surface of a roller used to convey the photosensitive film along a portion of the transport path.

Depending on the make-up of the photosensitive film, it may be self-supporting and hence require no carrier. However, in preferred embodiments, the photosensitive film is disposed on a photosensitive film carrier substrate, the photosensitive film carrier substrate preferably being substantially transparent in the visible spectrum. For example, a PET substrate would be suitable. The use of a substantially transparent substrate enables the reproduced pattern to be viewed from both sides. Additionally or alternatively, it is preferable that the photosensitive film carrier substrate is at least semi-transparent to radiation of the predetermined wavelength. In this way exposure of the photosensitive film could take place from either side of the substrate. Advantageously, the photosensitive film carrier substrate comprises a polymeric material, preferably polyethylene teraphthalate (PET), biaxially oriented polypropylene (BOPP), polyamides such as Nylon™, polyethylene, polymethylmethacrylate (PMMA), polyethylene naphthalate (PEN) or orientated polypropylene (OPP).

The photosensitive film may be applied to the carrier substrate using any suitable technique and this may be carried out in a separate, preparatory process, often by a different entity. The prepared film can then be stored (shielded from radiation) until needed. However, in other implementations the formation of the film may form part of the disclosed method which therefore may further comprise applying the photosensitive film to the photosensitive film carrier substrate, preferably by printing or coating. It should be noted that the photosensitive film need not be a continuous, uniform layer but could be patterned, defining shapes and/or gaps therein.

The particular waveband to which the photosensitive material is responsive will depend on the selected diazonium compound. In preferred examples, the predetermined wavelength is in the ultraviolet (UV) to violet range of the EM spectrum, preferably between 10 nm and 460 nm, more preferably between 380 and 410 nm.

Whilst it is particularly preferred that the exposed elements of the photosensitive film receive a radiation dose which is sufficient to cause decomposition of substantially all the diazonium compound in those elements (such that substantially none remains to form a dye with the dye coupler, thereby maximising the contrast between the exposed and unexposed pattern elements), this is not essential. A visible pattern will still be achieved provided at least some of the diazonium compound in the exposed regions is decomposed, such that the concentration of dye ultimately formed in the exposed elements is less than in the unexposed elements. Indeed, in some embodiments it may be preferable to allow both the exposed and unexposed elements to take on some colour (but to differing degrees, the unexposed elements carrying a more intense or optically dense colour than the exposed elements), in order to increase the overall proportion of the element that is coloured. In preferred embodiments, the radiation dose received by the exposed elements decomposes at least 50% of the diazonium compound originally present in those elements of the photosensitive film, more preferably at least 75%, most preferably at least 90%. Similarly, it is preferred that the unexposed elements receive no radiation of the relevant wavelength and hence undergo no decomposition. However in practice some radiation may be received by these elements, for example if any mask used to form the pattern is not 100% opaque. Nonetheless any decomposition of the diazonium compound in these elements will always be less than in the exposed elements, and in preferred examples is kept to less than 25%, more preferably less than 10%.

The desired radiation dose applied during the exposure step will therefore depend on the desired contrast in the finished product, as well as on the selected diazonium compound. The dosage can be adjusted through control of the radiation source power and the duration for which each portion of the film is exposed. In preferred examples, the radiation to which the photosensitive film is exposed has a power between 30 and 300 W/cm, preferably between 50 and 200 W/cm, more preferably between 100 and 150 W/cm, most preferably around 120 W/cm. The unit “watts per cm” (W/cm) refers to the wattage per cm along the length of the radiation source, e.g. light bulb, since typically each portion of the photosensitive film will not see the power from the whole source but only from that part of the bulb which it passes. Advantageously, the photosensitive film is exposed to the radiation for a duration between 0.1 seconds and 2 minutes, preferably between 0.1 seconds and 10 seconds, more preferably between 0.5 seconds and 2 seconds.

As already discussed, a primary use of the method is to form high resolution patterns which are not readily discernible to the naked eye and hence, preferably, the predetermined pattern according to which the photosensitive film is exposed includes one or more elements having a minimum dimension (e.g. line width) of no more than 50 μm, preferably no more than 25 μm, more preferably no more than 15 μm, still preferably no more than 10 μm, most preferably no more than 5 μm.

Most preferably, the predetermined pattern according to which the photosensitive film is exposed is configured to exhibit a secure visual effect, (i.e. one which cannot readily be copied by standard processes such as photocopying), preferably an optically variable effect (i.e. an appearance which varies at different viewing angles) alone or in combination with a viewing component such as a second pattern layer, a masking grid, a focussing element or array of focussing elements. Any viewing component required to generate the desired optical effect may be incorporated in or applied to the photosensitive film or its carrier as discussed below, but could alternatively be comprised in an object such as a document of value into or onto which the photosensitive film is ultimately fitted, or could be part of a standalone device, such as a reader or decoder for testing the authenticity of the photosensitive film pattern.

Thus, in one example, the reproduction of the predetermined pattern may define microtext or microimages which are sufficiently small that they cannot readily be viewed by the naked eye. The photosensitive film could alternatively provide one or more of the pattern or image layers in any of the security devices described in our International Patent Application no. PCT/GB2012/052520. For example, two such patterned photosensitive films may be overlapped to form moiré interference devices or venetian blind devices using any of the techniques described in PCT/GB2012/052520 for exposing two joined films simultaneously or sequentially. Alternatively, two such films may be overlapped and joined after exposure and development.

Various different effects can also be achieved using a single patterned photosensitive film in combination with a viewing component overlapping (i.e. overlying or underlying) the pattern. This could be incorporated into a photosensitive film carrier substrate or could be provided as part of an object (such as a document of value) onto or into which the photosensitive film is ultimately applied or incorporated, to thereby complete the security device. The viewing component could itself comprise a pattern of visible elements, such as the masking grid described above, but can be fabricated using any appropriate technique including conventional printing methods or metallisation. Particularly strong optical effects can be achieved where the viewing component comprises one or more focussing elements, such as lenses or mirrors. For example, in one preferred implementation, the photosensitive film is disposed on a photosensitive film carrier substrate further comprising one or more focussing elements, or the method further comprises arranging one or more focussing elements to overlap the photosensitive film, the photosensitive film lying substantially in the focal plane of the focussing element(s), whereby a substantially focussed image of at least part of the predetermined pattern is generated. Advantageously, the focussing element(s) and predetermined pattern displayed by the photosensitive film form in combination a lenticular device. For example, the predetermined pattern may comprise elements of a first image and elements of a second image arranged such that when the lenticular device is viewed from a first angle, a focussed version of the first image is generated, and when the lenticular device is viewed from a second angle, a focussed version of the second image is generated. In this way, the device can be configured to exhibit a “switch” from the first image to the second image at a particular angle of view. More than two images can be provided to enable multiple “switches” at successive viewing angles and the images may be designed to give the appearance of an animation as the viewing angle changes. Further details and examples of lenticular devices which could be formed using a photosensitive film in this way are given in our International application WO-A-2011051670.

In another preferred example, the photosensitive film is disposed on a photosensitive film carrier substrate further comprising a regular array of micro-focussing elements, or the method further comprises arranging a regular array of micro-focussing elements to overlap the photosensitive film, the photosensitive film lying substantially in the focal plane of the micro-focussing elements, and the predetermined pattern displayed by the photosensitive film comprises a corresponding array of microimage elements, wherein the pitches of the micro-focusing elements and the array of microimage elements and their relative locations are such that the array of micro-focusing elements cooperates with the array of microimage elements to generate a magnified version of the microimage elements due to the moiré effect, the array of micro-focussing elements and predetermined pattern forming in combination a moiré magnification device. Examples of moiré magnification devices and effects that can be achieved are described in EP-A-0698256, WO-A-2005106601 and in our International Patent Application No. PCT/GB2011/050398, and the presently disclosed technique can be utilised to form the microimage elements described therein.

The security effect may be combined with one or more additional security features and in preferred examples, the provided photosensitive film (and/or its carrier) comprises one or more of the following, or the method further comprises applying one or more of the following to the photosensitive film:
An optically variable diffraction structure, preferably a diffraction grating or hologram;
An optically variable material, preferably an interference layer device, interference layer pigments or pearlescent pigments, or cholesteric liquid crystal layers or pigments; and
Luminescence, fluorescent, magnetic or thermochromic materials;
   each of which may or may not overlap the reproduction of the predetermined pattern exhibited by the photosensitive film. That is, the additional feature(s) may provide an effect which is independent of or combined with that to which the patterned photosensitive film contributes.

It is also preferred that the device is arranged to be machine-readable. This may be achieved in a number of ways. For example at least one layer of the device (optionally as a separate layer) may further comprise machine-readable material. Preferably the machine-readable material is a magnetic material, such as magnetite. The machine-readable material may be responsive to an external stimulus. Furthermore, when the machine-readable material is formed into a layer, this layer may be transparent. Detectable materials that react to an external stimulus include but are not limited to fluorescent, phosphorescent, infrared absorbing, thermochromic, photochromic, magnetic, electrochromic, conductive and piezochromic materials.

The exposed and developed photosensitive film may undergo additional processing steps which differ depending on how the security device is ultimately to be formed and/or handled. In many cases the processed photosensitive film will be output as a security article which can go on to be applied to or incorporated into an object of value, such as a document of value. In this context, a “security article” is an item such as a thread, strip, label, foil, patch or the like, which can be incorporated into an object to enable its authenticity to be tested by way of a secure effect exhibited. Security threads are now present in many of the world's currencies as well as vouchers, passports, travelers' cheques and other documents. In many cases the thread is provided in a partially embedded or windowed fashion where the thread appears to weave in and out of the paper. One method for producing paper with so-called windowed threads can be found in EP0059056. EP0860298 and WO03095188 describe different approaches for the embedding of wider partially exposed threads into a paper substrate. Wide threads, typically with a width of 2 to 6 mm, are particularly useful as the additional exposed area allows for better use of overt security features such as those formed using the currently disclosed techniques.

However, it should be noted that, by itself, the security article may or may not exhibit a secure effect (i.e. act as a security device). For instance, if one or more components necessary to generate the visual effect are provided in the object of value rather than the photosensitive film, the security device may only be completed once the security article is combined with the object. However, in many cases it is preferred that whilst it is preferred that the photosensitive film is incorporated into a substrate web which itself carries all components necessary to view the desired optical effect generated by the pattern, in which case the security article will indeed include a security device. In a first preferred example, the exposed substrate web the exposed photosensitive film forms all or part of a security article for application onto or incorporation into an object of value, preferably a document of value, the security article preferably taking the form of a thread, strip or band. As such, once the film has been exposed and any additional components applied to it (e.g. a viewing component such as an array of lenses), the photosensitive film or portions thereof can be directly applied to or incorporated into an object of value.

In a particularly preferred example, the method further comprises applying the exposed photosensitive film onto or incorporating it into a sheet material to form a security sheet suitable for the production of documents of value, and preferably then cutting the security sheet into individual documents. For example, a reel of the exposed photosensitive film (plus any additional layers) can be fed into a paper-making process to incorporate the film as a thread within the paper sheet.

In other preferred examples, the method further comprises cutting the exposed the exposed photosensitive film into individual security articles for application onto or incorporation into an object of value, preferably a document of value, the security articles preferably taking the form of a foil, patch, thread, strip or insert. The or each security article can then be applied onto or incorporated into one or more objects of value, preferably documents of value. Again, the individual security articles may or may not carry completed security devices.

In another preferred example, the output of the manufacturing process may be a transfer band, whereby the photosensitive film is provided on a photosensitive film carrier substrate and a release layer is disposed between the photosensitive film and the carrier substrate, portions of at least the exposed photosensitive film constituting security articles, the security articles preferably taking the form of labels or transfer foils in the form of patches or stripes. The or each security article can then be detached from the carrier layer and affixed onto one or more objects of value, preferably documents of value. This could be performed by hot stamping or, if the articles are formed as stickers, each may simply be peeled off the carrier and adhered to the object, manually or otherwise. If the security device is to be used in a label application it will typically require the application of a heat or pressure sensitive adhesive to the outer surface of the device which will contact the secure document. In addition an optional protective coating/varnish could be applied to the exposed outer surface of the device. The function of the protective coating/varnish is to increase the durability of the device during transfer onto the security substrate and in circulation.

In the case of a transfer element rather than a label the photosensitive film is preferably prefabricated on a carrier substrate and transferred to the document substrate in a subsequent working step. The security device can be applied to the document using an adhesive layer. The adhesive layer is applied either to the security device or the surface of the secure document to which the device is to be applied. After transfer the carrier strip can be removed leaving the security device as the exposed layer or alternatively the carrier layer can remain as part of the structure acting as an outer protective layer. A suitable method for transferring security devices based on thick devices comprising micro-optical structures is described in EP 1897700.

Due to the generally transparent nature of the exposed elements of the photosensitive film, many of the optical effects achieved are advantageously viewed in transmission or from both sides of the finished devices. Therefore the method preferably further comprises applying the security article to or incorporating the security article into a sheet material, preferably a document of value, in alignment with at least one window provided in the sheet material before or after affixing of the security article, whereby at least one reproduction of the predetermined pattern(s) displayed by the photosensitive film is visible from at least one side, preferably both sides, of the sheet material, through the window. The sheet material could, for example, go on to form the basis of a document of value such as a banknote or page of a passport, or another object of value such as a tag for attachment to products such as clothing, etc. The security document may have a substrate formed from any conventional material including paper and polymer. Techniques are known in the art for forming transparent regions in each of these types of substrate. For example, WO8300659 describes a polymer banknote formed from a transparent substrate comprising an opacifying coating on both sides of the substrate. The opacifying coating is omitted in localised regions on both sides of the substrate to form a transparent region.

EP1141480 describes a method of making a transparent region in a paper substrate. Other methods for forming transparent regions in paper substrates are described in EP0723501, EP0724519, EP1398174 and WO03054297.

As noted above, whilst it is usually preferred that all components of the finished device are incorporated into the security article, this is not essential and in other examples it may be beneficial to provide some of the components in the object to which the security article will ultimately be applied. In one example, the method further comprises applying the security article to or incorporating the security article into an object, preferably a document of value, the object comprising a viewing component aligned with at least part of the reproduction of the predetermined pattern, whereby the viewing component and the predetermined pattern in combination exhibit a secure visual effect. As mentioned already, a viewing component is any feature which modifies the appearance of the pattern so that, in combination, a secure visual effect (preferably an optically variable effect) is perceived. Masking grids and focussing elements are examples of viewing components.

In other examples, the photosensitive film itself or its carrier substrate may form the basis of one or more object of value, the security device thereby being formed integrally with the object. In this case, the method preferably further comprises cutting the substrate web into individual objects, each object displaying at least part of the predetermined pattern. For example, the web may be cut into a series of banknotes, each carrying one of the security devices to which the exposed pattern contributes. The photosensitive film carrier substrate may be printed or coated before or after exposing the photosensitive film, the printing or coating defining a window which is at least semi-transparent in the visible spectrum, and the window containing region(s) of the photosensitive film which have been or will be exposed, such that at least part of the reproduction of the predetermined pattern is displayed in the window.

The invention further provides a security device component made using any of the methods set out above.

In a third aspect of the invention, a security device component is provided comprising an exposed photosensitive film exhibiting a multi-coloured pattern of elements, the elements in a first area of the photosensitive film comprising a first azo dye exhibiting a first colour, and the elements in a second areas of the photosensitive film comprising a second azo dye, different from the first, exhibiting a second colour.

As discussed above, the provision of multiple colours in this way significantly increases the difficulty of counterfeiting and therefore enhances the security level of the component or of a security device incorporating the component. The security device component can be manufactured using any of the techniques discussed above with respect to the first or second aspects of the invention, or any other technique.

It should be appreciated that the pattern “elements” exhibited by the photosensitive film (in all aspects of the present invention) are integral portions of the photosensitive film, delimited from one another by virtue of whether or not each portion has been exposed to radiation of the predetermined wavelength. This should be contrasted with features applied onto a film by printing or coating for example.

The first and second areas can be arranged in any of the ways already discussed with respect to the first and second aspects of the invention. Further areas of different colours can additionally be provided to further increase the complexity of the visual effect.

The invention further provides a security device comprising a security device component made using the methods of the first or second aspects of the invention, or in accordance with the third aspect of the invention. The security device may include one or more additional components to generate a secure visual effect using the reproduced pattern as discussed above.

Thus in one example, the security device further comprises a layer having a second pattern of elements overlapping the pattern exhibited by the photosensitive film, to form in combination a venetian blind device or a moiré interference device, having an appearance which differs at different viewing angles.

In other examples, the security device may further comprise one or more focussing elements defining a focal plane, the pattern exhibited by the photosensitive film being substantially coincident with the focal plane, whereby a focussed image of at least a portion of the pattern is generated. In one preferred example, the focussing element(s) and pattern form in combination a lenticular device, the pattern preferably comprising sections of a first image and sections of a second image arranged such that when the lenticular device is viewed from a first angle, a focussed version of the first image is generated, and when the lenticular device is viewed from a second angle, a focussed version of the second image is generated.

In another advantageous embodiment, the security device further comprises a regular array of micro-focussing elements, the pattern exhibited by the photosensitive film being substantially coincident with the focal plane, and the pattern exhibited by the photosensitive film comprising a corresponding array of microimage elements, wherein the pitches of the micro-focusing elements and the array of microimage elements and their relative locations are such that the array of micro-focusing elements cooperates with the array of microimage elements to generate a magnified version of the microimage elements due to the moiré effect, the array of focussing elements and predetermined pattern forming in combination a moiré magnification device.

The present invention further provides a security article comprising a security device component made using the methods of the first or second aspects of the invention, or in accordance with the third aspect of the invention or a security device as discussed above, the security article preferably being a thread, a strip, a foil, a patch, a transfer, a label or an insert.

Also provided is an object of value comprising a security device component made using the methods of the first or second aspects of the invention, or in accordance with the third aspect of the invention or a security device or a security article (both as discussed above), the object of value preferably being a document of value such as a banknote, a cheque, a passport, a visa, a tax disc, an ID card, a certificate, a stamp, a ticket, a share certificate, a drivers' license, or a certificate of guarantee.

Examples of manufacturing methods, security device components and security devices in accordance with the present invention will now be described with reference to the accompanying drawings, in which:

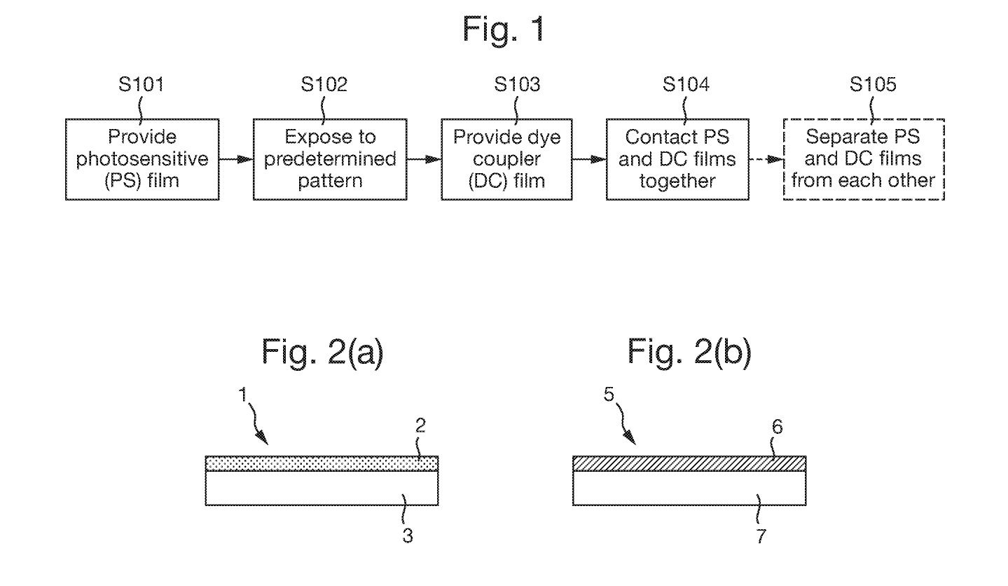

FIG. 1 is a flow chart depicting steps of a first embodiment of a method for manufacturing a security device component;

FIGS. 2a and 2b schematically depict portions of a photosensitive substrate and a dye coupler film respectively, in cross-section;

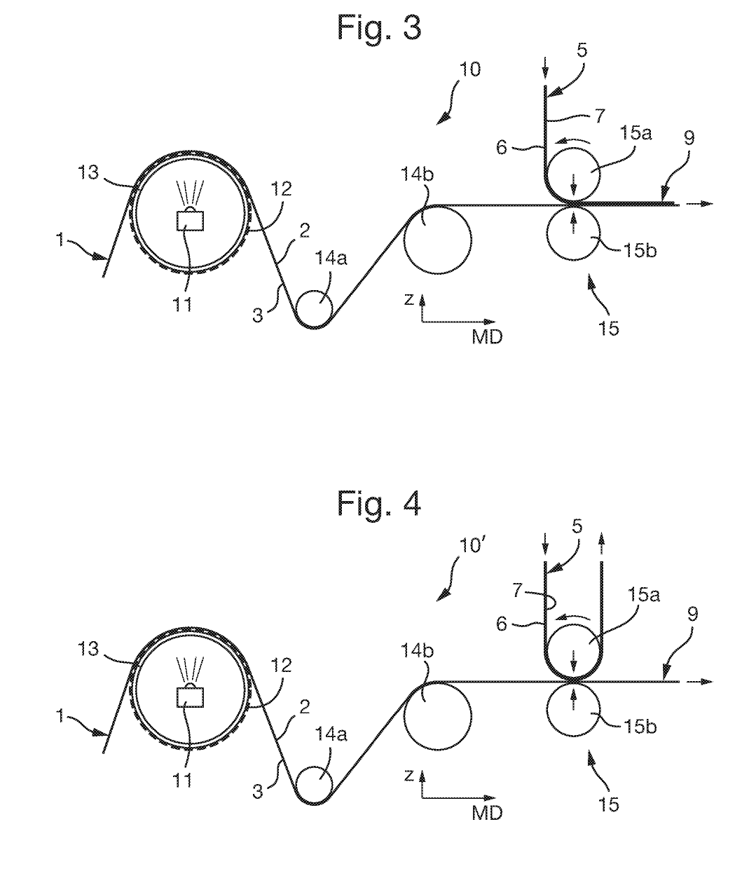

FIG. 3 shows first exemplary apparatus for implementing the method of FIG. 1 in a first variant;

FIG. 4 shows second exemplary apparatus for implementing the method of FIG. 1 in a second variant;

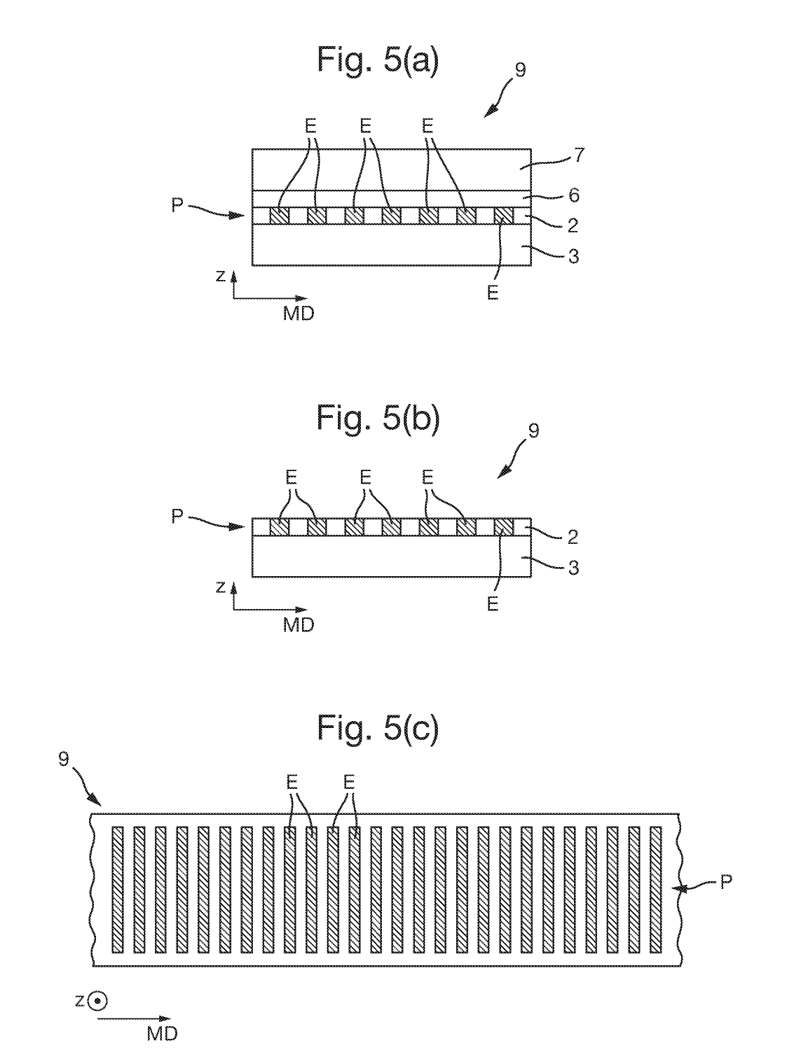

FIG. 5(a) shows a portion of an exemplary security device component manufactured using the apparatus of FIG. 3 in cross section, FIG. 5(b) shows a portion of an exemplary security device component manufactured using the apparatus of FIG. 4 in cross section, and FIG. 5(c) shows a plan view of either security device component;

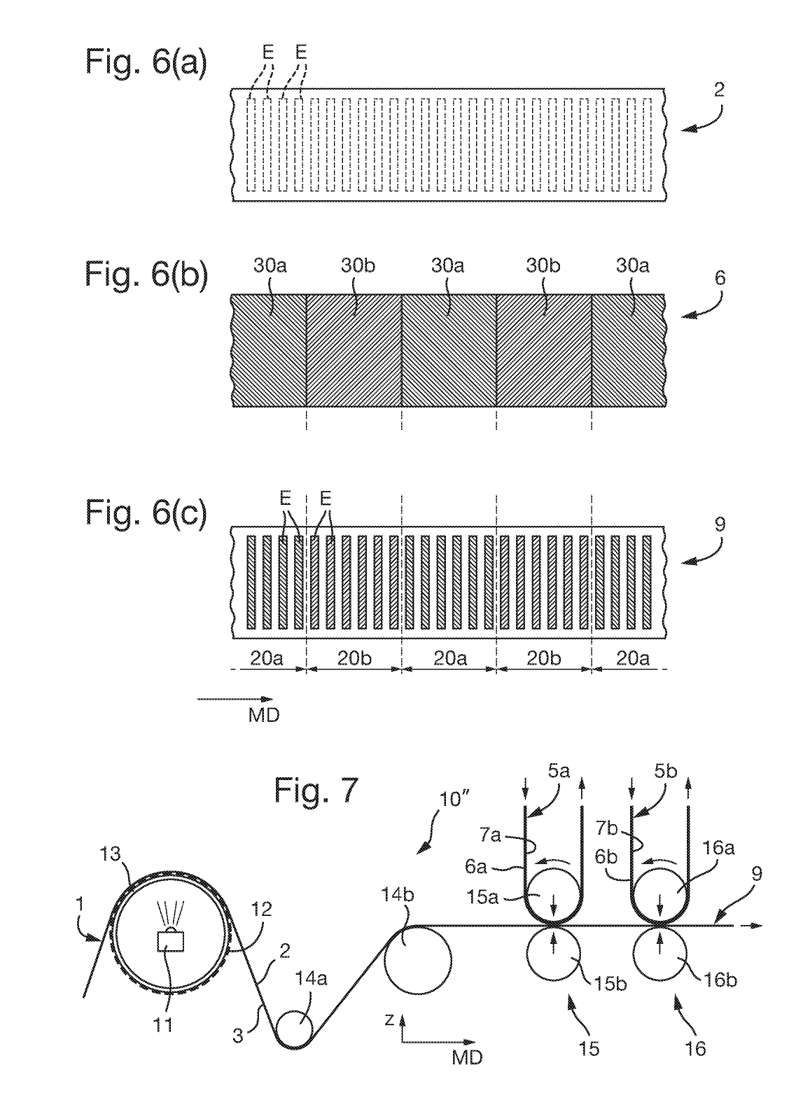

FIG. 6 shows, in a second embodiment of a method for manufacturing a security device component: (a) a portion of an exemplary exposed photosensitive film prior to development, (b) a portion of an exemplary dye coupler film, and (c) a portion of the photosensitive film (a) after contact with the dye coupler film (b);

FIG. 7 shows exemplary apparatus for implementing a third embodiment of a method for manufacturing a security device component;

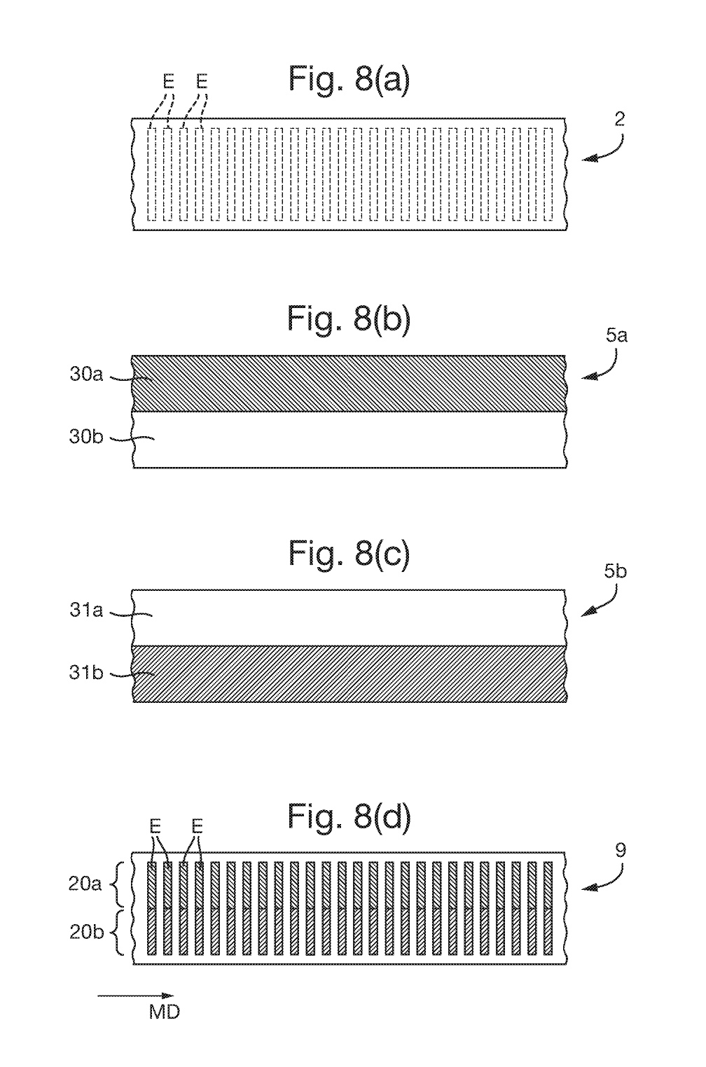

FIG. 8 shows, in the third embodiment of a method for manufacturing a security device component: (a) a portion of an exemplary exposed photosensitive film prior to development, (b) a portion of a first exemplary dye coupler film, (c) a portion of a second exemplary dye coupler, and (d) a portion of the photosensitive film (a) after contact with the dye coupler films (b) and (c),

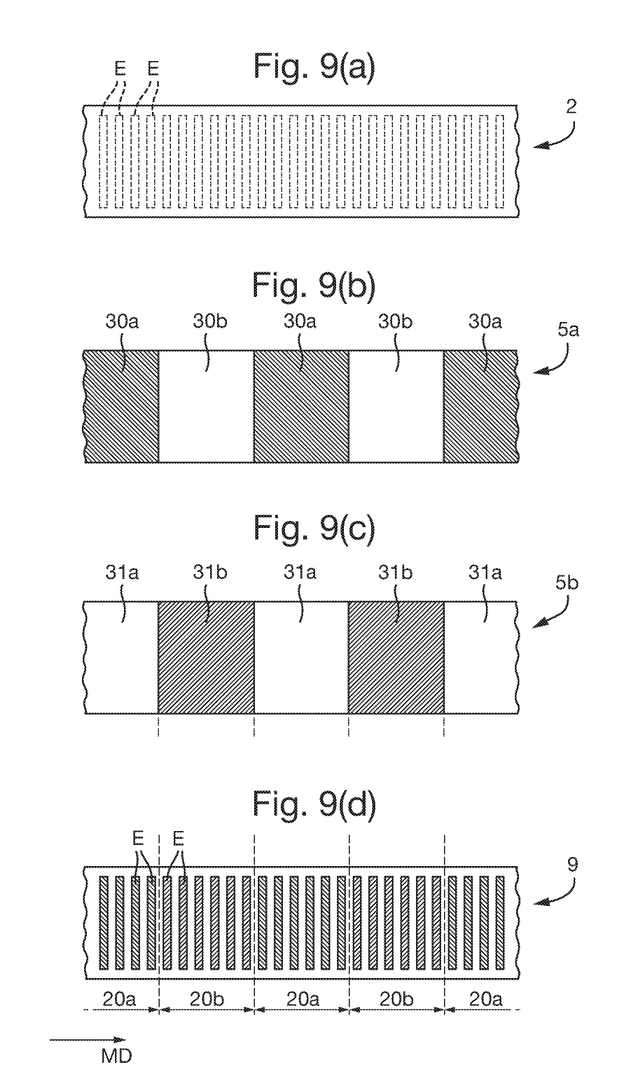

FIG. 9 shows, in a fourth embodiment of a method for manufacturing a security device component: (a) a portion of an exemplary exposed photosensitive film prior to development, (b) a portion of a first exemplary dye coupler film, (c) a portion of a second exemplary dye coupler, and (d) a portion of the photosensitive film (a) after contact with the dye coupler films (b) and (c);

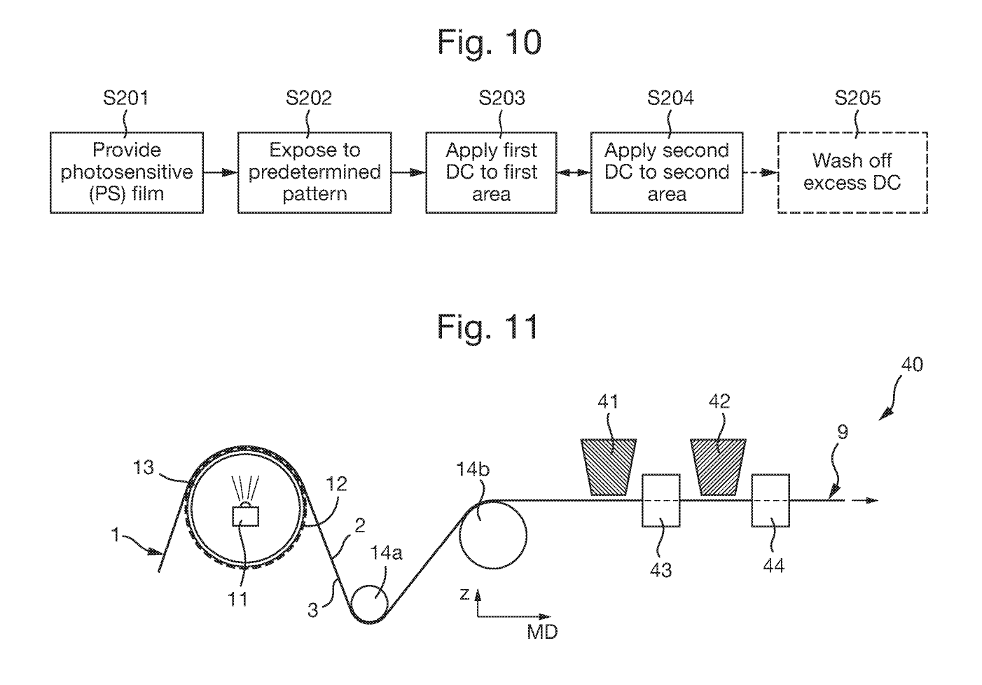

FIG. 10 is a flow chart depicting steps of a fifth embodiment of a method for manufacturing a security device component;

FIG. 11 shows exemplary apparatus for implementing the method of FIG. 10;

FIGS. 12(a), (b), (c) and (d) schematically depict four examples of security device components that may be manufactured using any of the disclosed methods;

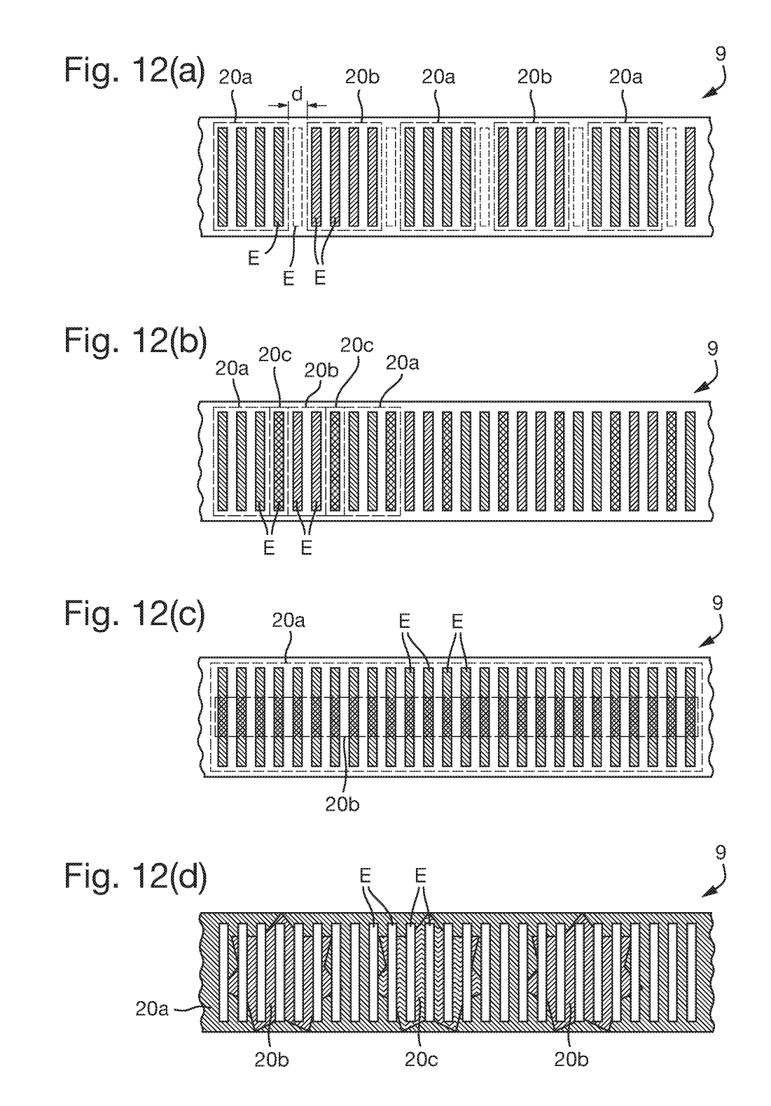

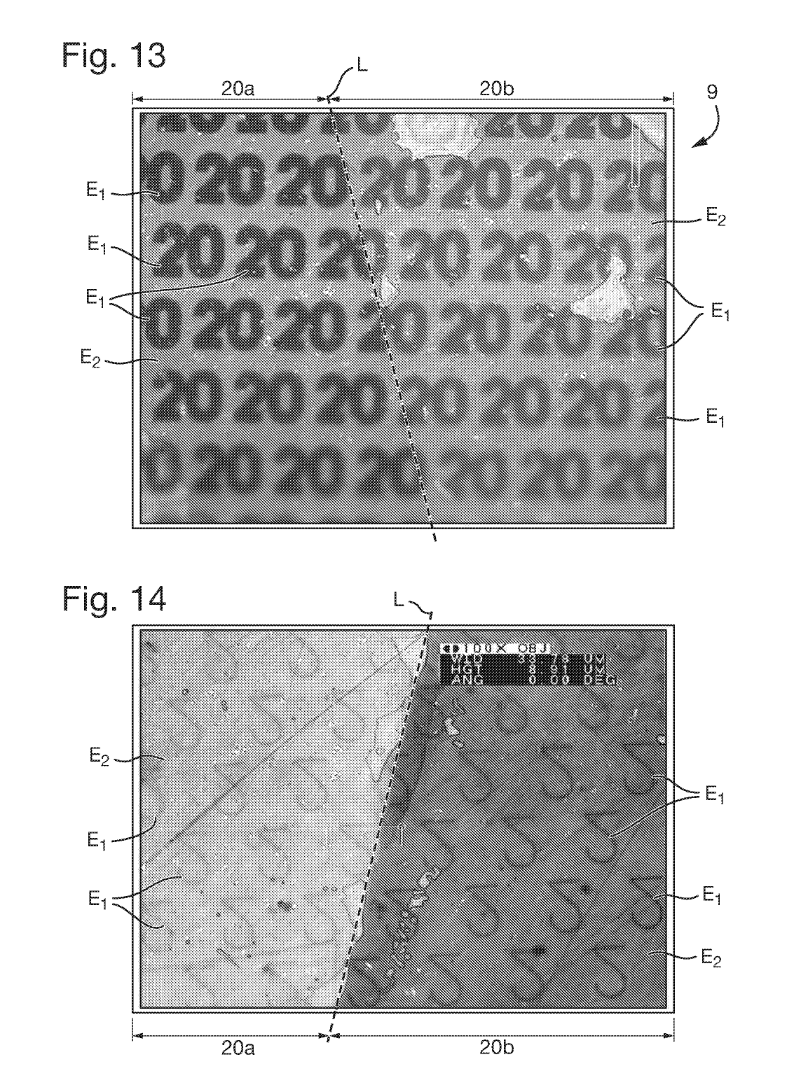

FIGS. 13, 14 and 15 are magnified images of three exemplary security device components that many be manufactured using any of the disclosed methods;

FIG. 16 depicts further exemplary apparatus for implementing methods in accordance with the invention;

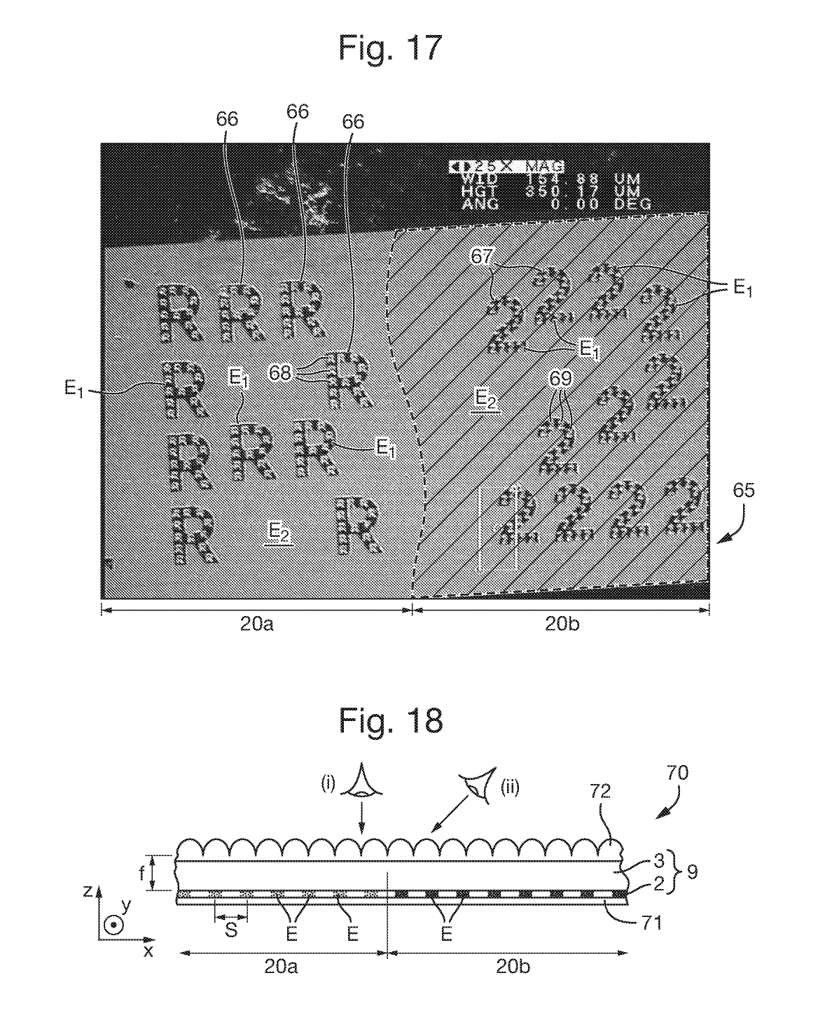

FIG. 17 is a magnified image showing in plan view a first embodiment of a security device comprising a security device component as may be manufactured using any of the disclosed methods;

FIG. 18 schematically depicts a second embodiment of a security device comprising a security device component as may be manufactured using any of the disclosed methods;

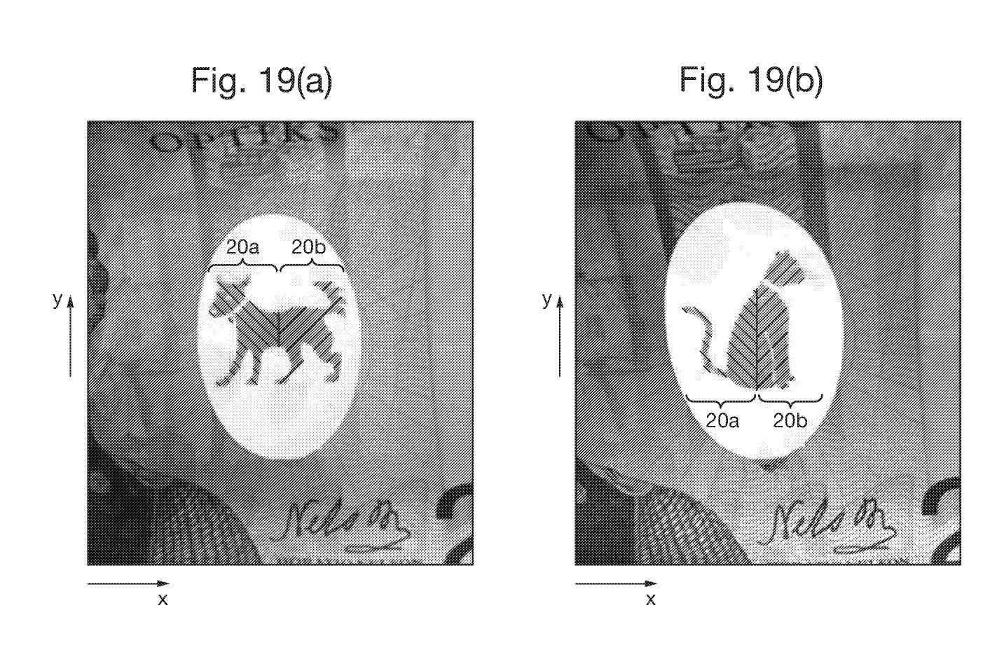

FIGS. 19(a) and 19(b) are images showing a security device of the type depicted in FIG. 18 from two different viewing angles;

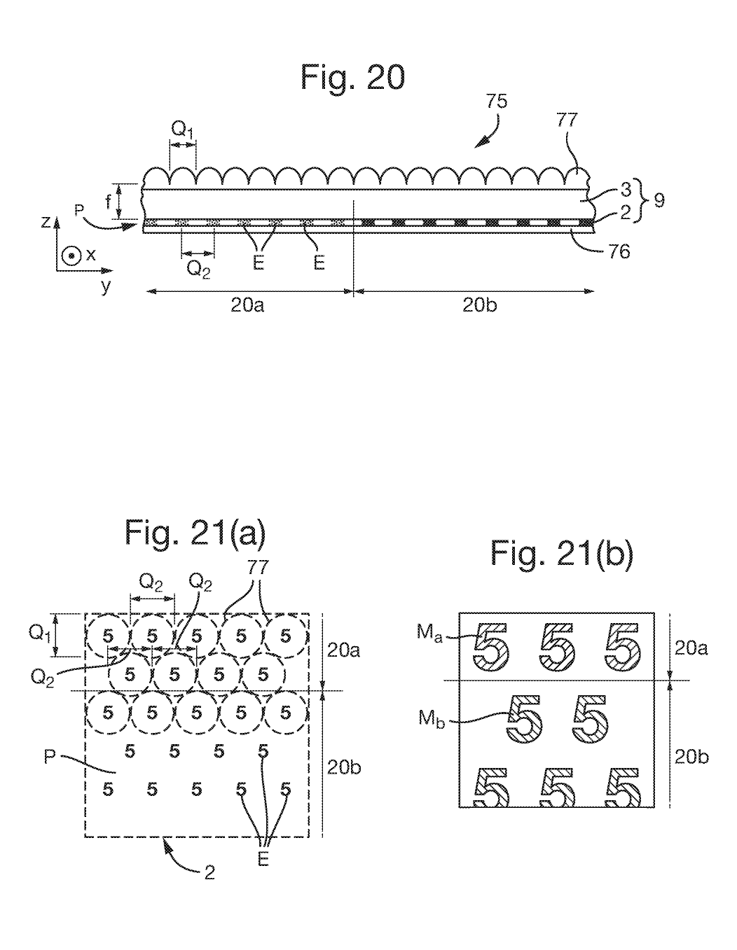

FIG. 20 is a schematic cross section of a third embodiment of a security device;

FIG. 21(a) illustrates an exemplary microimage element pattern as may be used in the embodiment of FIG. 20, FIG. 21(b) illustrating a magnified version thereof as may be generated by the device;

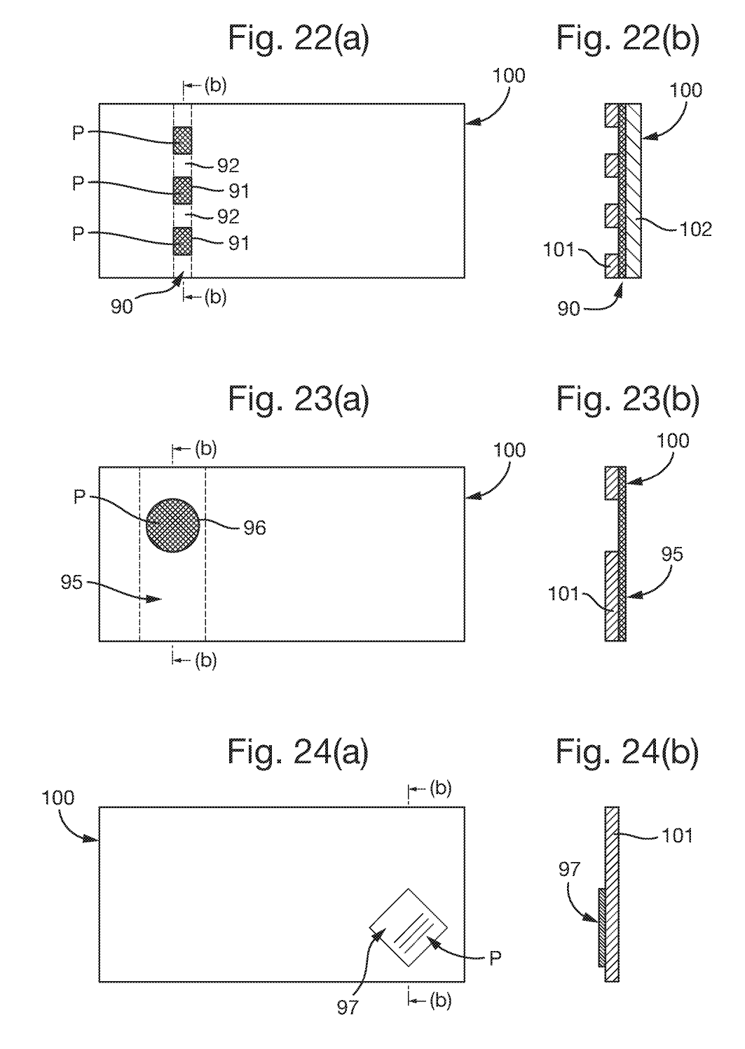

FIGS. 22 to 24 depict three embodiments of objects of value each having a security article including a security device, in (a) plan view and (b) cross section;

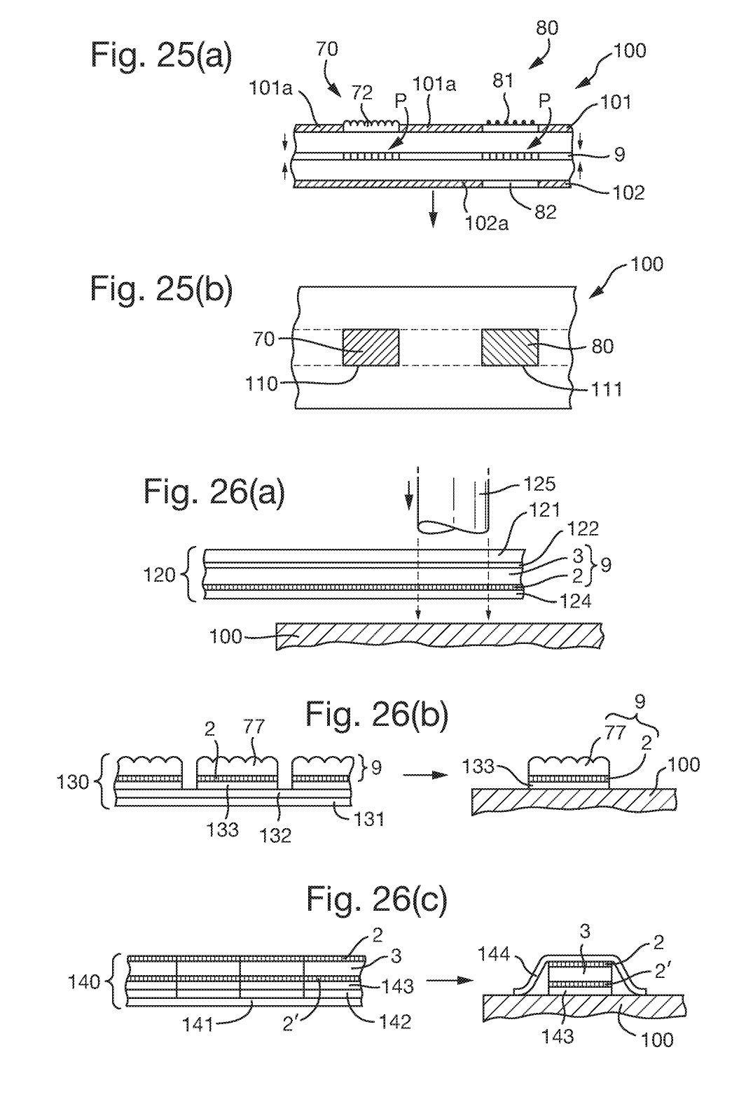

FIG. 25(a) is an exploded view of a portion of an object of value in another embodiment incorporating two security devices, FIG. 25(b) depicting the assembled object of value in plan view;

FIG. 26(a) depicts a further embodiment of a security article formed as a transfer band during application to an object of value, FIG. 26(b) shows an embodiment of a security article formed as a transfer sheet and subsequent cross section once applied to an object of value and FIG. 26(c) depicts another embodiment of a substrate security article formed as a transfer sheet and subsequent cross section once applied to an object of value; and

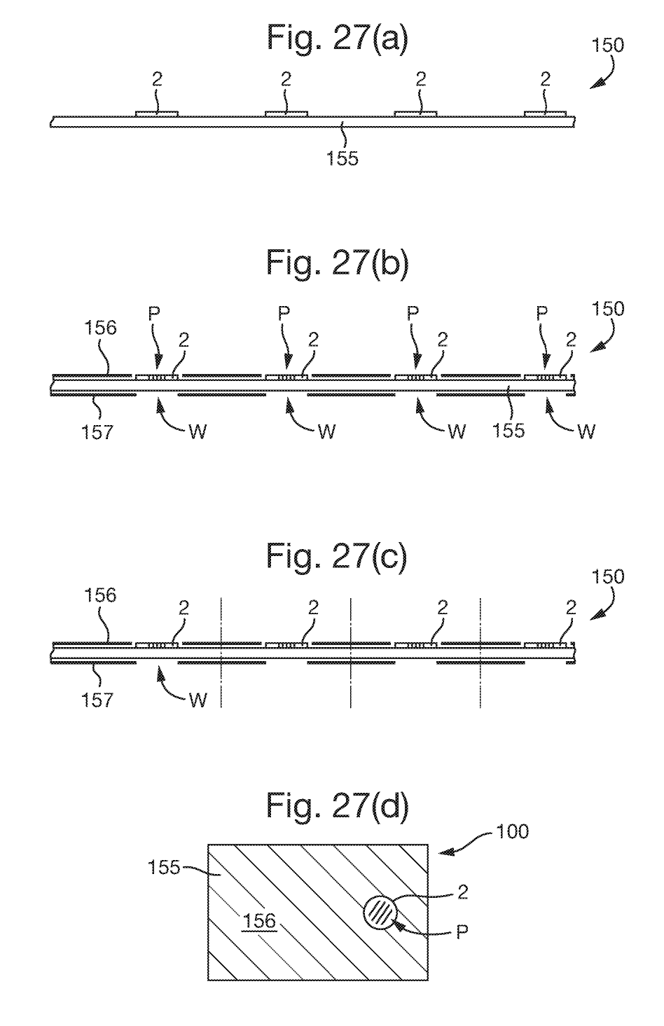

FIGS. 27a, 27b, 27c and 27d depict a further embodiment of a security device component and processing steps resulting in an embodiment of an object of value incorporating a security device.

In the following, improved methods for photographic reproduction of patterns will first be described which are particularly suitable for the formation of high-resolution patterns for use in security devices. These methods can be used to produce patterns of single or multiple colours. Subsequently, the use of these and other methods for the formation of multi-coloured methods will be described, and examples of multi-coloured security device components provided. Finally, examples of security devices which incorporate any of the described security device components (single or multi-coloured) will be described, together with examples of how such devices may be incorporated into objects of value such as security documents.

FIG. 1 is a flow diagram depicting steps in a manufacturing method according to a first embodiment of the invention. In a first step S101, a photosensitive (PS) film 2 is provided, which comprises a diazonium compound such as a diazonium salt. Typically the diazonium compound is dispersed in a binder substance, such as a resin. If the resulting material is self-supporting, the photosensitive film may be provided as a monolithic film. However, more preferably the photosensitive film is supported on a carrier substrate 3, to form a photosensitive substrate web 1 of which an example is shown in cross-section in FIG. 2(a). The photosensitive film 2 can be applied to the carrier 3 by any suitable method such as printing or coating and typically this may be performed in a separate process, possibly by a different entity to that carrying out the method of FIG. 1, in which case the photosensitive film may be supplied dry and ready for use, e.g. on a reel, in step S101. Examples of suitable photosensitive materials are discussed below.

In the next step S102, the photosensitive film 2 is exposed to radiation of a wavelength which causes at least partial decomposition of the diazonium compound, in accordance with a predetermined pattern P. The wavelength or waveband to which the material is responsive will depend on its particular composition, but typically this is in the ultra-violet (UV) range of the spectrum, e.g. between 10 nm and 460 nm, more preferably between 380 and 410 nm. Various techniques can be used for performing the exposure, e.g. through a mask carrying the master pattern, or by directing a laser beam of the appropriate wavelength over the film in accordance with the desired pattern, and particularly preferred examples will be given below. At this stage, the exposed portions of the photosensitive film are not visually well-distinguished from the unexposed portions and hence the pattern is not clearly visible on the film (in practice the image may be weakly apparent but it is not easy to see).

A dye coupler (DC) film 5 is then supplied to the process (step S103) and this includes at least a dye coupler composition 6, which comprises a dye coupler (or a mixture of multiple dye couplers), typically dispersed in a binder such as a resin. A dye coupler is a substance which will react with the diazonium compound in the (unexposed parts of) photosensitive film 2 to produce a dye, typically an azo dye. The resulting dye preferably has a colour visible to the human eye, although in other cases the “colour” of the dye could be outside the visible spectrum (though detectable by a machine). The dye coupler composition could be supplied as a standalone film 6 if it is self-supporting, but more preferably, the composition is applied to a carrier substrate 7 to form the dye coupler film 5. An example is shown in FIG. 2(b). In this example, the same dye coupler composition 6 is applied uniformly across the carrier substrate 7 but as discussed below this need not be the case in all implementations.

The photosensitive film 1 and dye coupler film 5 are brought into contact with one another in step S104, with the photosensitive layer 2 directly placed against the dye coupler composition 6. Any suitable technique can be used to achieve contact, e.g. layering the films on top of each other in a sheet-by-sheet process. However, in preferred examples contact is achieved by introducing both films into a nip between two rollers, as will be discussed below. Upon contact, at least some of the dye coupler diffuses from the dye coupler film 5 into the photosensitive film 2. In the unexposed regions of the photosensitive film, the diazonium compound reacts with the dye coupler to form the aforementioned dye, rendering those portions visible (or machine readable), and thereby creating a reproduction of the desired pattern on the photosensitive film 2. In the exposed regions of the photosensitive film, if decomposition of the diazonium compound has been complete, there will be no reaction and the region will remain colourless (or at least unchanged in colour)—this is preferred in order to maximise the contrast between the pattern elements. However in some embodiments it may be preferred to control the exposure so that not all of the diazonium compound is decomposed, such that some dye is formed in the exposed regions but at a lower concentration than in the unexposed regions, resulting in a weaker colour. The reproduced pattern is still visible due to the different colour intensities between the exposed and unexposed elements.

Depending on the particular compositions selected, the contacting step S104 may additionally comprise heating the films and/or applying an elevated pressure to the films, to promote the diffusion of the dye coupler into the photosensitive film and/or to assist the dye reaction. This can be achieved in various ways, e.g. by providing a heater and/or press, but in particularly preferred examples a heated nip between rollers is used to achieve both.

The photosensitive film 2 with its developed pattern constitutes a security device component and all further steps are therefore optional. However at this stage the photosensitive film and dye coupler film are still in contact and whilst this may be desirable in some cases, generally it is preferred to separate the two films in step S105. Depending on the particular pattern utilised the so-formed security device component may itself form a security device or may be incorporated into a structure with other components to form a security as will be discussed below.

FIG. 3 depicts exemplary apparatus 10 for implementing a first variant of the method of FIG. 1, without optional separation step S105. The photosensitive substrate 1, comprising photosensitive film 2 and carrier substrate 3 is conveyed past a radiation source 11 which emits UV light of the appropriate wavelength to which photosensitive film 2 is responsive. The radiation from source 11 is patterned by a mask 12, which here is carried by a roller 13 with the source 11 positioned inside. The roller 1 is substantially transparent, at least to the appropriate wavelength of radiation (UV in this example). In this case the carrier substrate 3 is also substantially transparent to the radiation so that exposure of the photosensitive film 2 can take place through the carrier layer 3. For example, a PET carrier is generally suitable for this purpose. The exposure may alternatively be performed with the radiation source on the side of the photosensitive film (e.g. with the photosensitive film in direct contact with the mask 12), which has the benefit that the resolution of the image formed on the film is optimised. The mask 12 comprises elements which are substantially opaque to the radiation and elements which are substantially transparent, arranged in accordance with the predetermined pattern P to be formed. It should be noted that the respective mask elements need not be entirely opaque and transparent to the radiation (although this is preferred), since provided the dosage of radiation received by each set of elements is different, a pattern will still be formed. The mask pattern and exposure apparatus can be implemented in the same manner as disclosed in our International Patent Application No. PCT/GB2012/052520.

The exposed photosensitive film 2 is then conveyed along a transport path, here comprising rollers 14a and 14b, in the machine direction MD to a nip 15 defined between two rollers 15a, 15b. Also introduced to the nip 15 is the dye coupler film 5, comprising dye coupler composition 6 and carrier substrate 7. The two films 1, 5 are arranged such that the dye coupler composition 6 faces and is brought into direct contact with the photosensitive film 2. The dye 15 may optionally be heated and/or may apply pressure urging the two films towards one another. Upon contact, the dye coupler diffuses from the dye coupler film 5 into the photosensitive film 2 causing the unexposed pattern elements of the photosensitive film to take on a colour such that a reproduction of the predetermined pattern P is exhibited by the photosensitive film. The resulting structure, comprising the two films 1, 5 in contact, constitutes a security device component 9.

A cross section through an exemplary security device component 9 formed in this way is shown in FIG. 5(a). The developed photosensitive film, exhibiting pattern P formed of coloured exposed elements E, is located between the photosensitive film carrier substrate 3 on one side, and the dye coupler film formed of dye coupler composition 6 and carrier 7 on the other. Provided the two carrier substrates 3, 7 are visually transparent or semi-transparent (e.g. tinted), the pattern P can be viewed from either side of the construction. The retention of carrier substrates on both sides of the photosensitive film 2 helps to protect the pattern and therefore may be desirable in certain applications. The structure can be incorporated into security devices, security articles or objects of value as discussed below.

However, in many applications to keep the component as thin as possible—e.g. devices incorporated into banknotes are required to be thin in order to maintain the flexibility of the note and to enable neat stacks to be formed—and so in a preferred variant of the method, after the photosensitive film and dye coupler have been contacted against one another and the pattern developed, the two films are separated. Modified apparatus 10′ for this purpose is shown in FIG. 4. The completed security device component 9 now comprises only the developed photosensitive substrate 1, with the photosensitive film 2 exhibiting the reproduced pattern, as shown in FIG. 5(b).

FIG. 5(c) shows the security device component 9, formed by either method, in plan view. In this case, the predetermined pattern is a regular array of linear pattern elements E which have been masked from the radiation source and hence react with the dye coupler to take on a colour. In this case, since the dye coupler film 5 has a uniform coating of one dye coupler composition, all the unexposed pattern elements E will exhibit the same colour. The background surrounding the pattern elements E has been exposed to the radiation and (assuming the exposure has been sufficient to decompose all of the diazonium compound therein, which is not essential) therefore does not reach, remaining substantially colourless and providing a strong visual contrast with the developed pattern elements E.

Two exemplary formulations A, B of the photosensitive film 2 are as follows:
A) VHL 31534 (a vinyl resin, which comes in a propyl acetate solvent at 25% solids, from Sun Chemicals), 9.0 g
   Acetone, 2.0 g
   R-11 FB (from Varichem), 1.0 g
B) UCAR VMCH resin (a vinyl acetate/vinyl chloride/maleic acid terpolymer from Dow chemicals), 2.7 g
   Methyl ethyl ketone, 6.3 g
   Acetone, 2.0 g
   R-11 FB, 1.0 g

In both of these examples, R-11 FB provides the diazonium compound. Its chemical name is 2,5-Diethoxy-4-(4′-tolylthio)-benzenediazonium fluoroborate. Other exemplary photosensitive films which can be used include vesicular film as supplied by Exopack in the USA (Matthews) and Imagemaster Diazo film as supplied by Dupont. The Imagemaster film additionally contains a dye coupler admixed in the photosensitive layer, which is generally not preferred in the presently disclosed methods, but tests using this film in the presently disclosed methods did achieve a different colour result from that arising from the dye coupler contained in the film itself. As such photosensitive films of this sort can be used but are less well suited to the present methods, particularly where multiple colours are desired on the final product since the dye coupler already present in the photosensitive film reduces the colour contrast between areas.

Some exemplary formulations of the dye coupler composition 6 are:

1) VC-55 (from Varichem), 0.5 g
VHL 31534, 8.0 g
Triethanolamine, 0.3 g
   2) VC-39 (from Varichem), 0.5 g
VHL 31534, 8.0 g
Triethanolamine, 0.3 g
   3) VC-18 (from Varichem), 0.5 g
Glascol LS24 (an aqueous emulsion of an acrylic copolymer from Ciba) Potassium hydroxide, 0.2 g
Water, 1.0 g

In the above, VC-55 has the chemical name 4-(Cyanoacetyl)-morpholine, VC-39 has the chemical name 3-Hydroxy-N-[2′-methylphenyl]-2-naphthalenecarboxamide, and VC-18 has the chemical name 3,5-Dihydroxy-N-(2-hydroxyethyl)benzamide.

The colour exhibited by the unexposed pattern elements E will depend on which dye coupler composition is selected for the dye coupler film 5. In combination with either exemplary photosensitive film compositions A or B, dye coupler composition 1) gives a yellow colour, dye coupler composition 2) gives a blue colour whilst dye coupler composition 3) gives a red colour.

In one example, a dye coupler film 5 was prepared by printing one of the dye coupler compositions 1), 2) or 3) onto a carrier 7 of corona treated PET, and allowed to dry. A photosensitive film 2 was formed by coating photosensitive composition A onto a carrier substrate 3 of corona treated PET and allowed to dry to give a 4 gsm film. This was then exposed to UV radiation of approximately 254 nm wavelength through a patterned mask using a low pressure mercury lamp at 120 W/cm for approximately 1 second. At this point there was no clearly visible image on the photosensitive film.

The dye coupler layer 6 was then placed in contact with the exposed photosensitive film 2 and then sent through a heated nip with a pressure of approximately 80 g/linear cm at around 100° C. at a speed of 20 meters a minute. The dye coupler film was then removed, leaving the photosensitive film, now exhibiting a pattern corresponding to that of the mask, in a single colour dependent on the dye coupler composition selected.

The application of heat and/or pressure to the films during contact is optional but preferred in many cases, in order to enhance diffusion of the dye coupler into the photosensitive film. The optimum temperature and/or pressure will depend on the selected photosensitive material, dye coupler and the binder system in which each is carried. In preferred examples, the pressure applied by the nip may be in the range 80 to 4000 grams/linear cm (along the nip in the transverse direction). Preferred temperatures lie in the range 75 to 140 degrees C., more preferably in the range 90 to 130 degrees C., most preferably around 100 degrees C. The diffusion rate achieved will also influence how long contact between the films should be maintained to allow an adequate quantity of the dye coupler to diffuse to the photosensitive film. In preferred examples, the contact between the exposed photosensitive film and the dye coupler film has a duration between 1 and 10 seconds.

It is also preferable that the diffusion coefficient of the dye coupler into the photosensitive film is higher than that of the diazonium compound (in either layer) at the conditions under which contact takes place, and this is the case for each of the exemplary formulations given above. This is desirable since a relatively high level of diazo diffusion could lead to lateral “spreading” of the unexposed pattern elements, and hence reduce the resolution of the reproduced pattern. The diffusion coefficients of the diazonium compound and of the dye coupler will depend on their chemical compositions as well as those of the binder systems in which each is disposed, and on the temperature/pressure conditions. The diazonium compound in the component R-11 FB used in the exemplary formulations above has low diffusivity and thus is an advantageous choice although alternative substances could be used.

The dosage of radiation to which the photosensitive film is exposed will also have an effect on the final pattern exhibited since if not all of the diazonium compound in each exposed portion of the film is decomposed by the radiation, some reaction with the dye coupler may take place upon contact with the dye coupler film, leading to a lower contrast level with the unexposed portions (which may or may not be desirable). In preferred examples, the radiation to which the photosensitive film is exposed has a power between 30 and 300 W/cm, preferably between 50 and 200 W/cm, more preferably between 100 and 150 W/cm, most preferably around 120 W/cm. The unit “watts per cm” (W/cm) refers to the wattage per cm along the length of the radiation source, e.g. light bulb, since typically each portion of the photosensitive film will not see the power from the whole source but only from that part of the bulb which it passes. Advantageously, each portion of the photosensitive film is exposed to the radiation for a duration between 0.1 seconds and 2 minutes, preferably between 0.1 seconds and 10 seconds, more preferably between 0.5 seconds and 2 seconds.

In the above example, a single dye coupler composition is utilised and hence the reproduced pattern is of a single corresponding colour. However, the method is particularly well suited for the manufacture of multi-coloured patterns, and this can be achieved in various ways.

FIG. 6 shows (a) an exposed photosensitive film 2, (b) a dye coupler film 6, and (c) the resulting security device component 9 in a second embodiment of a method for manufacture thereof. The apparatus of FIG. 3 or FIG. 4 could be utilised. In FIG. 6(a), the unexposed pattern elements E are depicted in dashed lines since at this stage they are not clearly visually distinguishable from the rest of the photosensitive film 2, which has been exposed to radiation of the relevant wavelength. The dye coupler film 6 is now made up of multiple areas 30a, 30b each of which carries a different dye coupler composition. For example, the areas 30a may carry dye coupler formulation 1) mentioned above whilst the areas 30b may carry dye coupler formulation 2). This can be achieved by printing, coating or otherwise applying the two (or more) different dye coupler compositions onto the carrier 7 to form the dye coupler layer.

In this example, the areas 30a, 30b are arranged as repeating blocks resulting in a series of stripes in the machine direction MD. However any arrangement of the different dye coupler compositions is feasible and further examples will be given below. It should also be noted that the two or more dye coupler compositions need not cover the whole of the dye coupler carrier 7. In some cases it may be desirable to include gaps in the dye coupler coverage, which will lead to corresponding gaps in the pattern exhibited by the developed photosensitive film (this also applies to dye coupler films of a single dye coupler composition).

The photosensitive film 2 is brought into contact with the dye coupler film 6 in the same manner as discussed above. The various different areas of the dye coupler film 6 come into contact with corresponding different areas of the photosensitive film. As a result, the unexposed pattern elements E in each area take on a different colour depending on the dye coupler with which they have made contact. For example, if dye coupler formulation 1) mentioned above is used in areas 30a of the dye coupler film, the corresponding areas 20a of the photosensitive film 2 appear yellow, whilst if dye coupler formulation 2) is used in areas 30b of the dye coupler film, the corresponding areas 20b of the photosensitive film 2 appear blue. The result is a multi-coloured reproduction of the pattern to which the photosensitive film 2 was exposed.

The present technique is particularly well adapted for the formation of multi-coloured patterns in this way since the dry nature of the lamination reduces the possibility of smudging occurring at the boundaries between two regions.

Whilst in the above example, the dye coupler compositions are applied to the dye coupler film in abutting, non-overlapping areas 30a, 30b, any other arrangement resulting in at least two areas of different overall dye coupler composition from one another could be used. For example, depending on the register achievable between the different dye couplers when applying them onto the film, the dye couplers may partially overlap one another or may be spaced from one another on the film. This may be a result of mis-register or may be purposely designed, and can be used to increase the complexity of the finished colour pattern. More than two different dye coupler compositions could also be applied to the dye coupler film.

In a modification of this method, two or more dye coupler films 5 could be used to apply the different dye couplers to the photosensitive film 2. Two examples of this approach will now be described with reference to FIGS. 7, 8 and 9. FIG. 7 depicts exemplary apparatus for carrying out the method and it will be seen that this is substantially the same as that discussed in relation to FIG. 4 above, except for the provision of a second nip 16 for the introduction of a second dye coupler film 5b following the end of contact between the photosensitive film 2 and the first dye coupler film 5a. In this example, the construction of nip 16 is the same as that of nip 15, comprising two opposing rollers 16a, 16b. Again, the nip 16 may be adapted to apply heat and/or pressure to the films as they pass through (the temperature and/or pressure may or may not be the same as that applied at nip 15). The second dye coupler film 5b has the same general construction as that of the first dye coupler film 5a, discussed above, i.e. one or more dye coupler compositions 6b carried on a carrier substrate 7b. One or both of the dye coupler films 5a, 5b will be patterned in order that different areas of the photosensitive film ultimately receive different dye couplers (or combinations of dye couplers).

FIG. 8 shows the various films in a first example. FIG. 8(a) shows the exposed photosensitive film 2 and as before the unexposed pattern elements E are depicted in dashed lines since at this stage they are not visible. FIG. 8(b) shows the first dye coupler film 5a and FIG. 8(c) shows the second dye coupler film 5b. In this example, both dye coupler films 5a, 5b are divided into two areas parallel to the machine direction MD. The first dye coupler film 5a carries a first dye coupler composition in its upper area 30a, whilst its lower area 30b carries no dye coupler composition. The second dye coupler film 5b carries no dye coupler composition in its upper area 31a, and has a second dye coupler composition (different from that on the first dye coupler film 5a) in its lower area 31b. Thus, after sequential contact with both films 5a and 5b, the photosensitive film will appear as shown in FIG. 8(d). Now, the unexposed pattern elements are visible and each exhibits two distinct colours: the upper part of each pattern element E, falling inside area 20a, exhibits a colour resulting from the dye coupler composition in area 30a of first dye coupler film 5a, whilst the lower part of each pattern element E, falling inside area 20b, exhibits a different colour resulting from the dye coupler composition in area 31b of second dye coupler film 5b. Hence, a multi-coloured reproduction of the pattern is formed.

It will be noted that the same end result could be achieved by using two unpatterned dye coupler films, each of half the width of the photosensitive film 2, with each being brought into contact with the respective area 20a, 20b of the photosensitive film 2 by offsetting the position of contact of each dye coupler film in the direction transverse to the machine direction MD. This may be advantageous in that the dye coupler films can be supplied as standard consumables with the pattern on the finished security device component being determined by the manner in which they are brought into contact.

FIG. 9 shows a further example of the use of two dye coupler films and again the apparatus of FIG. 7 may be used. FIG. 9(a) shows the exposed photosensitive film and (invisible) pattern elements E. FIGS. 9(b) and (c) show first and second dye coupler films 5a and 5b, and FIG. 9(d) shows the finished security device component 9. In this example, each dye coupler film 5a, 5b carries a pattern of areas offset along the machine direction MD. The first dye coupler film 5a carries a first dye coupler composition in areas 30a, and nothing in areas 30b which space areas 30a from one another. The second dye coupler film carries a second (different) dye coupler composition in areas 31b, and nothing in areas 31a, which space areas 31b from one another. The two films are sequentially brought into contact with the photosensitive film 2 in respective nips 15, 16 in such a way that the areas 30a, 30b on the first film 5a are registered to the areas 31a, 31b on the second film 5b. The resulting pattern shown in FIG. 9(d) is the same as that discussed above in relation to FIG. 6(c), i.e. the unexposed pattern elements E in areas 20a of the film 2 will exhibit a first colour and those in areas 20b will exhibit a second, different colour.

The result shown in FIG. 9(d) could also be achieved through the use of two dye coupler films each having a uniform coating of the first or second dye coupler composition respectively, if the manufacturing apparatus 10 is adapted such that each nip 15, 16 is configured to bring the respective dye coupler film alternately into and out of contact with the photosensitive film. This could be implemented by arranging the rollers 15a and 16a to move towards and away from the photosensitive film at the appropriate times. However, this would increase the complexity of the processing line.

It will be appreciated that in the methods of FIGS. 7 to 9, the registration between the first and second dye coupler films (in the machine direction MD and/or in the transverse direction) may or may not be exact, and in some cases the films may purposefully be arranged such that their respective areas partially overlap, or are spaced from one another. This can be used to create additional colour effects on the photosensitive film as will be discussed below.

Each dye coupler film could also carry more than one dye coupler composition in different areas, to achieve a more complex pattern of colours on the security device component 9.

Multi-coloured security device components of the sort described above can also be manufactured without the use of a dye coupler film, and another embodiment of a suitable method will now be described with reference to FIGS. 10 and 11.

FIG. 10 is a flow diagram setting out steps in the method, and FIG. 11 depicts exemplary apparatus 40 for carrying out the method. Items depicted using the same reference numerals as previously are the same as those introduced above.

The first steps S201 and S202 are the same as steps S101 and S102 of the previously described methods. That is, a photosensitive film 2 is provided, preferably as shown in FIG. 2(a), and is exposed to radiation in accordance with a predetermined pattern P, e.g. through a mask 12 in the same way as described previously. Next, first and second (different) dye coupler compositions are applied to respective first and second areas of the exposed photosensitive film 2 in steps S203 and S204. The two dye coupler compositions could be applied to the photosensitive film simultaneously or sequentially, in any order, as represented by the double-headed arrow between steps S203 and S204 in FIG. 10. The two dye coupler compositions can be applied by any suitable method such as printing or coating the compositions onto the photosensitive film. In a particularly preferred example, gravure printing is used but alternative techniques include flexographic, lithographic, screen or intaglio printing, all of which are suitable for the formation of secure patterns such as fine lines and guilloches. In still further examples, digital printing methods, such as ink-jet printing, can be used and these are particularly well suited for applying individual patterns such as personalisation data, since the applied pattern can be changed “on the fly”. In the example depicted in FIG. 10, two printing or coating stations 41, 42 are shown, one for the application of each dye coupler composition. The unexposed pattern elements within each respective area of the photosensitive film will take on a different colour in dependence on the dye coupler composition applied to that area, resulting in security device component 9 with a multi-coloured pattern.

Optionally, any excess dye coupler composition applied to the photosensitive film may be washed off in step S205. In practice, this may be implemented as a single washing step at the end of the process or (as shown in FIG. 9) a wash bath 43, 44 may be provided after the application of each dye coupler composition to help prevent blurring between different areas. Preferably washing is performed with an acidic solution to neutralise any alkali as may typically form part of the dye coupler compositions.

The photosensitive film 2 can again take any of the compositions discussed above in relation to the previous embodiments, including exemplary formulations A or B.

Suitable dye coupler compositions for use in the present embodiment include the following exemplary formulations:

i) VC-48 (from Varichem), 0.5 g
Acetone, 4.0 g
Potassium hydroxide, 0.2 g
Water, 0.5 g
   ii) VC-55 (from Varichem), 0.5 g
Acetone, 4.0 g
Potassium hydroxide, 0.2 g
Water, 0.5 g
   iii) VC-39 (from Varichem), 0.5 g
Acetone, 4.0 g
Triethanolamine, 0.3 g
   iv) Methyl 3-hydroxy-2-naphthoic acid (from Aldrich) 0.5 g
Acetone, 4.0 g
Potassium hydroxide, 0.2 g
Water, 1.5 g
   v VC-18 (from Varichem), 0.5 g
Warm Methanol, 4.0 g
Potassium hydroxide, 0.2 g
Water, 0.5 g
   vi) 2-Naphthol (from Aldrich), 0.5 g
Acetone, 4.0 g
Triethanolamine, 0.3 g

VC-48 has the chemical name Phloroglucinol dehydrate: VC-55 has the chemical name 4-(Cyanoacetyl)-morpholine, VC-39 has the chemical name 3-Hydroxy-N-[2′-methylphenyl]-2-naphthalenecarboxamide, and VC-18 has the chemical name 3,5-Dihydroxy-N-(2-hydroxyethyl)benzamide. It will be noted that each composition (i) to (vi) includes an alkali (base) such as potassium hydroxide, which is typically desirable in order to promote the reaction between dye coupler and diazonium compound.

In combination with either of the photosensitive formulations A or B, each of the above dye coupler compositions reacts to form a dye of a different colour. Thus, dye coupler composition 1) gives a black colour; 2) gives a yellow colour; 3) gives a blue colour; 4) gives a purple colour; 5) gives a red colour and 6) gives a dark blue/black colour.

In one example, photosensitive formulation A was coated onto a corona treated PET substrate carrier and placed in an oven for 30 seconds to give a dry film of 6 gsm. The film was then exposed to UV radiation using a mercury lamp at 120 W/cm for 1 to 2 seconds, through a patterned mask. The mask was removed and dye coupler solution i) was drawn down on a first area of the film using a k-bar (this is an example of a coating process, and is similar to knife coating—a “k-bar” is a piece of equipment used to produce a uniform coating). Immediately an image appeared which was a direct copy of the mask film. The colour of this was black. Subsequently, dye coupler solution ii) was applied to a second area of the photosensitive film using the same process, resulting in a yellow image in that area. Thus, a multi-coloured security device component was produced.

Some examples of multi-coloured security device components 9 which can be made using any of the techniques described above with respect to FIGS. 1 to 11 are shown in FIG. 12. In all cases, the photosensitive film exhibits pattern elements of a first colour in one area and of a second, different colour in another area which is laterally offset, in the same manner as in the previous examples. In FIG. 12(a) the first area 20a and second area 20b are spaced from one another by a distance d. This may be desirable if overlap of the different dye couplers is to be avoided, in order to allow for a finite registration tolerance during the application of the different dye coupler compositions (either to the photosensitive film 2 or to a dye coupler film 5). In this example, certain unexposed pattern elements E fall in the spaces between areas 20a and 20b, in which case they will remain invisible. However this is not essential.

In the FIG. 12(b) example, the photosensitive film exhibits elements of at least three different colours, arising from partial overlapping between the first areas 20a to which the first dye coupler composition is applied, and the second areas 20b to which the second dye coupler composition is applied. The area of overlap is denoted 20c and in this example, unexposed pattern elements E falling within area 20c will exhibit a third colour different from the first and second colours. This will not always be the case since the formation of a “mixed” colour in this way depends upon the degree to which the diazonium compound reacts with each dye coupler. For instance, using the “dry” technique of FIG. 1, the relative ability of each dye coupler to diffuse from the dye coupler film(s) to the photosensitive film, as well as (if both dye couplers are provided on one film) the thickness of the overlap of one dye coupler on the other on the dye coupler film, will determine the finished colour. Where the dye couplers are applied sequentially, e.g. by printing in the method of FIG. 10, the relative quantities of dye coupler may need to be adjusted to ensure that there is a sufficient amount of (unreacted) diazonium compound still available for the second dye coupler to react with.

The first and second areas 20a, 20b can alternatively fully overlap one another provided at least one of the first and second areas is not wholly overlapped by the other—i.e. the two areas are not exactly co-extensive. An example of this is shown in FIG. 12(c). Here, the first area 20a comprises substantially the whole of the photosensitive film, whilst the second area 20b is a narrow strip extending along the machine direction of the film. The method is configured such that the application of the second dye coupler to the second area changes the colour produced by the first dye coupler in that area (i.e. produces a combined or mixed colour as described above), such that two distinct colours are visible on the finished pattern.

Whilst in all the above examples, the pattern to which the photosensitive film has been exposed has been shown as a “positive” pattern of coloured line elements, “negative” patterns can alternatively be formed, and an example is shown in FIG. 12(d). In this case, the linear pattern elements E are those portions of the film which have been exposed to the radiation, such that the diazonium compound has decomposed, and the remainder of the film (forming a background to the pattern) has been masked. Three different dye couplers have been applied to three different respective areas of the film. In a first area 21a, extending across the majority of the film and so forming a “background”, a first dye coupler composition has been applied and this area exhibits a uniform, first colour. In a second area 20b, which is shaped to define an indicium (here, a star shaped symbol), a second dye coupler composition has been applied resulting in a different colour. A third star-shaped area 20c has received a third dye coupler composition and thus exhibits a third colour. The linear pattern elements E remain uncoloured in all areas.

In all cases, It will be appreciated that the first and second areas (and any additional areas) could define any indicia such as symbols, graphics, alphanumeric characters, stripes, fine line patterns, guilloches, etc., whether the photographically reproduced pattern is positive or negative. The pattern of colours effectively constitutes a second pattern superimposed on the photographically exposed pattern. Preferably, the second pattern is periodic and typically this periodicity will be in the machine direction.

The different colours are advantageously overt, i.e. readily apparent to the viewer, and as such the first and second areas are preferably sufficiently large that they may be distinguished by the naked eye. Since the elements of the photographic pattern are preferably of very high resolution (e.g. less than 5 micron line width), this means that each of the first and second areas preferably encompasses a plurality of the photographic pattern elements (positive or negative). For example, each area may have dimensions of at least 100 microns, preferably at least 0.5 mm, more preferably at least 1 mm, in at least one direction, preferably in two orthogonal directions. Even larger areas will often be desirable, e.g. of several mm or even cm in each direction. Where the colour pattern is periodic, preferably the periodicity is at least 1 mm, more preferably at least 5 mm, still preferably at least 10 mm.

It will be appreciated that the examples of security device components 9 shown in the Figures so far are schematic and so the photographic pattern elements are not shown accurately to scale as compared with the dimensions of the film. The pattern elements E have been substantially enlarged in the Figures for clarity but in practice will generally not be visible to the naked eye. For instance, in preferred examples, the elements E of the photographic pattern may a minimum dimension (e.g. line width) of no more than 50 μm, preferably no more than 25 μm, more preferably no more than 15 μm, still preferably no more than 10 μm, most preferably no more than 5 μm. Line widths as small as 2 μm have been achieved.

In addition whilst for clarity all of the Figures so far have depicted the photographic pattern as a line pattern, any design of pattern could be implemented by appropriate configuration of the mask through which the photosensitive film is exposed (or appropriate control of any other patterning technique implemented). For example, the photographic pattern could comprise an array of symbols such as alphanumeric characters, or complex graphics.

Some practical examples of security device components made using the above-described techniques are shown in FIGS. 13, 14 and 15, which are magnified images of portions of the components, shown in grayscale. In each case one or more dashed lines L has been superimposed along the area boundaries to assist in distinguishing one colour area from another in the grayscale images.

In the FIG. 13 example, the photographic pattern comprises an array of positive pattern elements E₁, each in the form of the number “20” having a line width of approximately 20 microns. Each element “20” was masked from exposure to the radiation source, whilst the background E₂ was exposed, rendering the photosensitive film non-responsive. A first dye coupler composition has been applied to area 20a on the left side of line L, and a second dye coupler composition to area 20b on the right side. As a result, the elements E₁ depicting the number “20” appear blue in the first area 20a, and purple in the second area 20b. The background E₂, meanwhile, is colourless across both areas.

FIG. 14 shows another example of a security device component 9, in which the photographic pattern is an array of positive elements E₁ each forming the number “2” (shown upside-down). The line width of each element “2” is about 1 micron. Each element E₁ has been masked from the radiation whilst the surrounding background E₂ has been exposed, but only to a relatively low dosage of radiation with the result that the diazonium compound has not been entirely decomposed in the exposed regions. A first dye coupler composition has been applied to area 20a on the left side of line L, and a second dye coupler composition to area 20b on the right side. As a result, the digits “2” (E₁) appear strongly yellow and the background area E₂ appears weakly yellow in the first area 20a, whereas the digits “2” appear strongly blue and the background area E₂ appears weakly blue in the second area 20b.

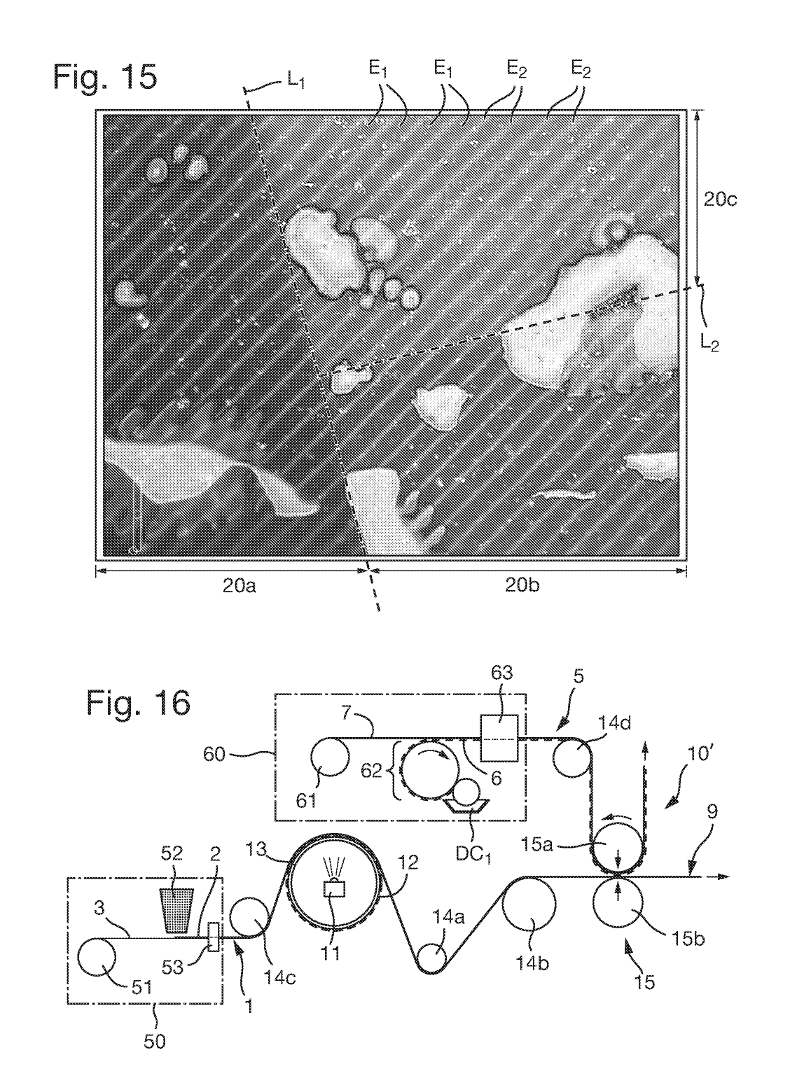

FIG. 15 shows a further example of a security device component which in this case exhibits three different coloured areas. (The clear, irregular patches are bubbles formed during the test process and should be ignored). The photographic pattern here is a series of parallel unexposed line elements E₁, here with a line width of about 30 microns, spaced by complementary exposed lines E₂. In a first area 20a to the left of line L₁, a first dye coupler composition has been applied resulting in the lines E₁ appearing blue. In a second area 20b in the bottom right corner of the Figure (to the right of line L₁ and below line L2, a second dye coupler composition has been applied resulting in red lines E₁. In the remaining, third area 20c, a third dye coupler has been applied and the lines E₁ are yellow.

Before turning to examples of how such security device components may be utilised, FIG. 16 depicts a further example of apparatus suitable for carrying out the method of FIG. 1 and includes equipment for optional additional steps which may be performed. As noted above, in the FIG. 1 technique, the photosensitive film and the dye coupler film can be manufactured in separate processes and supplied directly to the apparatus shown in FIG. 3 or 4 for exposure of the photosensitive film and subsequent contact with the dye coupler film. Preferably these steps are performed in an in line process (as already described), which allows for registration of the dye coupler pattern with the photographic pattern if desired (although this is optional). If desired, the photographic film and/or the dye coupler film could also be manufactured as part of the same inline process and FIG. 16 shows the scenario where both processes are incorporated into the procedure. Thus, the steps depicted in dashed-line boxes 50 and 60 are optional and in other cases will be performed separately from the subsequent up-stream process.

The manufacture of photosensitive film 1, depicted in box 50, comprises in this example providing a carrier substrate 3 from reel 51 and applying a photosensitive layer 2 onto the substrate at an application station 52, e.g. by coating or printing. It should be noted that whilst in many cases the photosensitive material may be applied in a continuous, all-over layer, this is not essential and the photosensitive film could consist of discrete regions and/or could encompass gaps. The photosensitive film is then dried and an oven or heater 53 may be provided for this purpose. The photosensitive film is then ready for use and may be conveyed directly to the exposure apparatus (as shown in FIG. 16) or could be stored for later use. It will be appreciated that this exemplary method of manufacturing the photosensitive film applies equally to the FIG. 10 method.

Box 60 shows the manufacture of an exemplary dye coupler film 5, here carrying a single dye coupler composition. A carrier substrate 7 is supplied from reel 61 and a dye coupler composition DC₁ is applied at an application station 62, here a print roller. As previously described the dye coupler composition can be applied according to any desired pattern and need not form a continuous all-over layer. If more than one dye coupler composition is to be carried by the film 5, additional application stations 62 can be provided in-line. The dye coupler(s) are then dried, and an oven or heater 63 may be provided for this purpose. The dye coupler film is then ready for use and may be conveyed directly to the contact nip 15 (as shown in FIG. 16) or could be stored for later use. If more than one dye coupler film is to be used, each can be made in the same way.

Some examples of security devices incorporating security device components of the sort set out above will now be described.

FIG. 17 depicts a security device 65 which could be formed using any of the previously described methods. In this example the device exhibits microtext, here representing the letter “R” and the number “2”, formed by exposing a photosensitive film 2 to radiation via a mask with a corresponding pattern. Elements E₁ (shown black in the Figure due to the black background) have been exposed to the radiation, whilst all other elements E₂ have been masked. The significantly enhanced print definition achieved with the photographic reproduction method enables microtext type devices to be formed at much smaller scales than possible using print-based techniques and still be clearly resolved when observed under high magnification. More complex microtext designs are also made possible and in the present example, each character of the device comprises an array of first-level microtext elements 66, 67 positioned so as to form the macro-sized elements “R” and “2” which can be observed without the need for magnification. Thus, the left hand portion of the device comprises ten first-level microtext letters “R” (items 66) which together form a macro-scale letter “R”, and the right hand portion of the device comprises 11 first-level microtext numbers “2” (items 67) arranged to form a macro-scale number “2”. The first-level microtext elements 66, 67 have a line width of around 50 μm which is achievable using conventional printing techniques (to a lesser degree of quality). However, in the present example, each first-level microtext element 66, 67 is itself made up of an array of second-level microtext elements 68, 69, each first-level microtext letter “R” being made up of 12 second-level microtext letters “R” (items 68) and each first-level microtext number “2” containing 11 second-level microtext numbers “2” (items 69). The second-level microtext elements 82, 87 have a line width of around 20 μm. This feature therefore provides a higher level of security than conventional microtext devices since the presence of the second-level elements (which will be detectable under magnification) will clearly distinguish a genuine device over a counterfeit version.

In addition, in this case the device 65 exhibits two different colours. In a first area 20a of the device, the background to the microtext as well as the second-level microtext characters 68 (i.e. the elements E₂) all appear in a first colour, resulting from a first dye coupler applied to that area. In a second area 20b of the device, the background and the second-level microtext characters all exhibit a second colour, different from the first. To assist in distinguishing the first and second areas, the Figure has been supplemented with a dashed line outlining the second area 20b and line-hatching denoting the second colour, but it will be appreciated that these are not present in practice.

FIG. 18 shows another embodiment of a security device 70 incorporating a security device component 9, in cross-section. Here, the device is a lenticular device and comprises a viewing component in the form of microlens array 72, e.g. an array of cylindrical lenses formed for example in a separate cast-cure process. An additional protective layer 71 has also been applied to the surface of photosensitive film 2, e.g. a lacquer, to protect it from damage during handling. In this example, the lens array 72 has been applied to the photosensitive film carrier substrate 3. In other cases, the microlens array 72 could form part of an object of value to which the security device component is later applied. Where lens array 72 is carried on carrier 3, it could be applied to the web after production of the photosensitive pattern, e.g. by lamination. However, in other implementations the lens array 72 may form part of the unexposed photosensitive substrate along with support layer 3 and photosensitive film 2. If appropriate, the support layer 3 could be omitted entirely and the photosensitive film 2 coated directly on the flat surface of lens array 72. In cases where the pattern is formed using a dye coupler film which remains in situ in the finished product, the lens array 72 could alternatively be applied to the dye coupler carrier 7.

At least the lens array 72 and carrier layer 3 are substantially visually transparent, and the pattern of unexposed elements E on the photosensitive film 2 is located at approximately the focal length f of the lens array 72. When viewed through the microlens array 72, the device therefore exhibits a focussed version of the pattern exhibited by photosensitive layer 2. Depending on the design of the pattern, the focussed image could be substantially the same at all different viewing positions. However, in preferred examples, the pattern formed on photosensitive layer 2 comprises interleaved portions of more than one image, e.g. a series of alternating image strips from two different images arranged along the x direction. In this way, when viewed from a first viewing position (i) shown in FIG. 18, only portions of a first image will be focussed, whereas when viewed from a second viewing position (ii), portions of a second, different, image will be focussed. The result is a device which exhibits a focussed, reconstructed image which appears to switch appearance when the device is tilted beyond a certain angle.

The aspect ratio of the distance between viewing component 72 and the photosensitive film 2 (here, the focal length f) to the spacing, s, between the pattern elements 3 on photosensitive film 2 determines the angle at which the switch will be perceived. The higher the ratio of f:s, the smaller the change in viewing angle necessary in order to perceive the change in image. Therefore, forming the pattern elements 3 on a photosensitive film as described above enables the spacing s to be reduced to a level far out-performing that achievable using conventional patterning techniques such as printing. This either can be utilised to obtain a higher aspect ratio of f:s without substantially changing the thickness of the device, leading to an enhanced optical effect, or to permit a reduction in the thickness of the device (provided lenses of suitable focal length are available) whilst still achieving a high impact optical switch.

In addition, the pattern exhibited by photosensitive film 2 is multi-coloured. In a first area 20a of the device, the unexposed pattern elements E possess a first colour, determined by the dye coupler which has been applied to that area, and in a second area 20b, the unexposed pattern elements E are of a second, different colour, due to the different dye coupler applied to that area. As a result different areas of the device appear to have different colours. Depending on the particular artwork selected, not all of the different areas need be visible at the same angle of tilt. For example, the artwork could be designed such that exposed pattern elements E are only visible in the first area 20a when the device is viewed from position (i), with the second area 20b appearing blank, and exposed pattern elements E only being visible in the second area 20b when the viewing angles changes to position (ii). In this way, tilting of the device would not only give rise to a change in the image (including a movement from area 20a to area 20b) but would also appear as a switch in colour.

FIGS. 19(a) and 19(b) show an example of a lenticular device formed based on the principles described above, viewed from two different angles. In this case, both colours are visible from both of the two different viewing angles depicted. FIG. 19(a) shows the appearance of the device when viewed directly from above and it will be seen that a focussed, reconstructed image of a dog is visible. In contrast, when the same device is viewed from an off-axis angle, an image of a cat is visible, as shown in FIG. 19(b). In both cases, the left side of the animal appears in a first colour, corresponding to area 20a, and the right side of the animal appears in a second colour, corresponding to area 20b. More complex colour arrangements are also possible.

Of course, the lenticular device could be configured to carry multiple sequential images if desired, thus appearing as an animated feature exhibiting for instance morphing, zooming or three-dimensional effects. Further examples of lenticular devices that can be constructed using the above described principles are given in our International Patent Application No. WO-A-2011051670.

A further embodiment of a security device 75 is depicted in cross-section in FIG. 20. Here, the device 75 is a moiré magnification device, the principles of operation of which are described in EP-A-0698256, WO2005106601A2 and in our International Patent Application Number PCT/GB2011/050398. The device comprises a viewing component in the form of regular microlens array 77, which in this example comprises an array of spherical microlenses such that a two-dimensional effect is achieved, although a one-dimensional version utilising cylindrical lenses is also envisaged. In this example, the microlens array is depicted as applied to the photosensitive film carrier 3 but, as in the previous embodiments, could alternatively be provided as part of an object of value to which the security device component 9 is applied. The multilayer structure of the device is otherwise generally similar to that of the lenticular device described above with reference to FIG. 18, with the patterned photosensitive film 2 being located substantially in the focal plane of the lenses 77, spaced by the optional transparent support layer 3. A protective layer 76 may again be provided.

The pattern P carried by the photosensitive film 2 comprises an array of microimage elements E and an example of such an array is depicted in FIG. 21a. Here, each microimage element E depicts a numeral “5”. The dotted line circles represent the position of the microlenses 77 relative to the image elements E. The microlenses have a pitch Q₁ which differs from the pitch Q₂ of the microimage array. This pitch mismatch gives rise to a magnification effect whereby each lens magnifies a different portion of the neighbouring microimage array elements, thereby forming in combination a magnified version of the array on a virtual image surface which appears in front of or behind the device. An example of such a magnified image panel is shown in FIG. 21b, and it will be seen that the magnified elements M_{a,b} are of generally the same appearance as the microimage elements E provided in the pattern P (but of course much greater in dimension). The degree of magnification achieved depends on the degree of pitch mismatch between the arrays.

Once again, the pattern P exhibited by the photosensitive film 2 is multi-coloured. In a first area 20a, the elements E exhibit a first colour whereas in a second area 20b, the elements E exhibit a second, different colour. As a result, the magnified images M also appear in multiple colours. In the first area 20a of the device, the magnified images Mₐ appear in the first colour, and in the second area 20b the magnified images M_{b} appear in the second colour.

As the device is tilted, different portions of each microimage element become magnified, and the magnified image panel therefore appears to move relative to the security device. Various additional effects can be achieved through design of the pattern to which the photosensitive film 2 is exposed, and examples of such effects and suitable microimage arrays through which they can be achieved are disclosed in our International patent application number PCT/GB2011/050398.

It should be noted that it is not essential that the microlens and microimage arrays have differing pitches. Instead, a suitable mismatch between the two arrays can be achieved by rotating one array relative to the other, which will also give rise to moiré magnification.

Lenticular and moiré magnification devices such as those depicted in FIGS. 18 and 20 may alternatively be formed using focussing mirror arrays in place of the described microlens arrays 72, 77. In this case, the array of mirrors would be disposed underneath the exposed photosensitive film 2. The use of focussing mirror arrays in lenticular and moiré magnification devices is described in WO-A-2011107793.

Many other types of security device can also be formed using patterns exhibited on a photosensitive film as described above. For example, the so-produced security device components could be used to form moiré interference devices or venetian blind devices in the manner described in our International patent application no. PCT/GB2012/052520 in relation to FIGS. 19 to 26. Each of these devices utilises two overlapping patterns of elements and in the present case either or both patterns could be formed on a photosensitive film as disclosed above. PCT/GB2012/052520 also discloses suitable methods for exposing two photosensitive films carried on both sides of a substrate to different patterns, which can be utilised in the presently disclosed methods also.

Post-development processing of the photosensitive film depends on how the finished security device is ultimately to be formed in or applied to an object of value. Three primary options are: (i) the security device component 9 can be processed into a security article, such as a label, foil or thread; (ii) the security device component 9 can be directly incorporated into an object of value such as a banknote; or (iii) the security device component 9 itself, carrying the photosensitive film, could be used as the basis of an object of value.

For example, after the photosensitive film has been exposed and the pattern developed as illustrated in FIG. 1 or 10, further processing steps may comprise cutting the so-produced web into individual security articles such as threads, strips or labels which can then be individually incorporated into or applied to objects of value. Alternatively the whole length of exposed web may itself constitute a security article, and could be applied to or incorporated into one or more objects of value (e.g. a web of such objects) without the need for any further processing steps. It should be noted that the security articles will each comprise a portion of the patterned photosensitive film but this may or may not by itself exhibit a secure visual effect (i.e. the security articles may or may not comprise a security device). For instance, to complete a security device from which the visual effect is apparent, it may be necessary to combine the security article with a viewing component (such as a lens array) provided as part of the object of value itself. In the following examples depicted in FIGS. 22 to 24, it is assumed that this is not the case and the security article itself carries all of the components necessary to perceive a secure optical effect, thereby forming a security device. For instance, the security article may comprise a substrate web having any of the structures depicted in FIGS. 17 to 21, discussed above.

FIG. 22 shows an embodiment of an object of value, here a document of value 100 such as a banknote, into which a security article 90 constituting a length of the exposed substrate web bearing a security device is incorporated. The substrate web may be cut into individual security threads 90 before insertion into the security document 100 but in preferred embodiments, a reel of the exposed substrate web may be fed into a paper-making process, for example, to form a web of documents which is then cut into individual documents of the appropriate size. Here, the thread 90 is incorporated as a windowed thread in between first and second plies 101 and 102 of the security document 100, at least one of the plies 101 having a series of windows 91 formed therein either during the paper-making process or subsequently (e.g. by grinding). The windows 91 thereby reveal portions of the security article 90 such that the pattern P carried by the photosensitive film is observable through the windows 91. Between the windows 91, sections 92 of the thread 90 are concealed by the overlying document ply 101. Alternatively, the windowed thread could be incorporated into single ply paper and produced using the method described in EP0059056.

FIG. 23 shows an alternative embodiment of a document of value 100, in which the substrate web is formed into strip articles 95 which are mounted to one side of a document substrate 101 in alignment with a window 96 which may be formed before or after application of the strip 95. The pattern P is observable through the window 96 and, depending on the construction of the substrate web from which strip 95 was constructed, it may be visible from the other side of the document 100 also. The strip 95 can be affixed to document ply 101 using an adhesive for example. As in the case of security thread 90, cutting of the substrate web into individual strips 95 may take place before or after incorporation with the document substrate 101.

FIG. 24 shows a further embodiment in which the substrate web has been formed into label articles 97 and affixed to a surface of a document 100. Here, the document substrate 101 may be opaque (e.g. paper), transparent or translucent (e.g. polymer substrate), or some combination thereof. For instance, the document substrate 101 could be transparent in the vicinity of the label 97 and substantially opaque elsewhere. As discussed below, label elements and/or transfer foils such as item 97 can be applied to a document in a number of ways and may not constitute the full layer structure of the substrate web once applied to the document of value 100.

FIG. 25 illustrates an example in which a security device is formed by a pattern carried on the photosensitive film in combination with one or more components forming part of the document of value 100 into which the photosensitive film has been incorporated (e.g. as a security article). FIG. 25(a) shows a cross section through a portion of document of value 100 with the various layers shown separated from one another for clarity. Here, a portion of the exposed substrate web (i.e. the security device component 9) is provided e.g. in the form of a thread, strip or insert, in between plies 101 and 102 of document 100 (although in other examples the web could be applied to one side of the document, as in FIG. 23 above). In the present example, the upper ply 101 is a substantially transparent polymer substrate which has been printed or coated upon most of its surface area 101a, leaving transparent window regions 70 and 80. Each of the window regions reveals a section of security device component 9 underneath which carries exposed pattern P (although the pattern may be different at the location of each window region). The construction is completed by a second document ply 102 which here is printed over area 102a to define a single window region 82 which aligns with window 80.

Window 70 includes a lenticular array 72 which is designed to co-operate with the underlying pattern P to form a lenticular device 110 based upon the principles discussed above with respect to FIG. 18. The device is primarily viewable in reflection but could be observable in transmission if the print on second document ply 102 is sufficiently translucent. In contrast, window 80 is provided with a printed grid pattern which acts in combination with the underlying pattern P to produce a moiré interference effect. Of course, any other type of device based on the photosensitive patterns can be produced by providing the appropriate viewing components in one or other of the document substrate plies 101 or 102.

FIG. 26 illustrates the case where the security device component 9 is formed into a transfer band which may be used to transfer security articles onto an object of value either in the form of transfer films or foils, or as labels/stickers. FIG. 26(a) shows a hot stamping approach in which the photosensitive film displays a microtext device such as that described with reference to FIG. 17 above. In this case, the photosensitive film 2 carrying the patterned microtext is positioned underneath transparent support layer 3 which sits on a carrier band 121 having a release layer 122 (e.g. wax). An adhesive layer 124 is provided over the photosensitive film 2. An appropriately shaped stamp 125 can then be used to transfer portions of the exposed substrate web onto objects of value 100, releasing the device structure from the carrier film 121.

FIG. 26(b) depicts an alternative transfer band configuration with a lenticular device structure, here incorporating a lenticular array 77 and patterned photosensitive film 2 disposed on the rear surface of the lens array, arranged to produce for example a moiré magnification effect as discussed above with reference to FIG. 20. The structure is formed in isolated regions on a transfer band 131 equipped with an adhesive layer 133 and release layer 132. Each individual article can be removed from the transfer band as a label/sticker and adhered to the surface of an object of value 100.

FIG. 26(c) shows another exemplary label structure in which the substrate web includes an optical structure such an a moiré interference device as discussed above, incorporating two patterned photosensitive films 2, 2′. The structure is provided with an adhesive layer 143 on a carrier film 141 provided with release layer 18142. In this case the individual label articles are not spaced from each other on the transfer band. The optical layers can be pre-cut into desired shapes to form labels which can then be individually peeled off the carrier film 141 and placed using a manual or automated process on an object of value, affixed by means of adhesive layer 143.

As for other types of security article, the transfer bands described here need not include all of the components necessary to generate the optical effect since the foil/label could be transferred onto an object in alignment with a viewing component incorporated into the document or applied later.

In each of the above examples, the pattern is formed on a photosensitive film which is then incorporated into or applied onto an object of value in the form of a security article. However, it is entirely possible to form the photographic pattern integrally with an object of value, such as a document of value, and an example of how this might be achieved will now be described with reference to FIG. 27.

FIG. 27(a) depicts a section of a substrate web 150 comprising a support layer 155 with isolated regions of photosensitive film 2 applied thereon, e.g. by printing or coating. Here, the support layer 155 is a conventional document substrate material such as a polymer banknote substrate or paper. The support layer 155 may or may not be pre-printed and may or may not already carry one or more additional security devices such as magnetic threads. The substrate web 150 is processed as described above with reference to FIG. 1 or 10, such that a pattern P is transferred into each photosensitive film portion 2. The result is shown in FIG. 32(b). In this example, as also shown in FIG. 32(b), the support layer 155 is then coated on both sides with an opaque layer 156/157 which omits the photosensitive film portions 2 and a region of the opposite side of the support layer 155 such that a window is formed surrounding each photosensitive pattern P (assuming the support layer 155 is visually transparent or translucent). In other cases, the coating 156/157 could be continuous across the window areas W on one side of the structure, resulting in half-window regions. The coatings 156/157 could if desired be provided before the exposure takes place, or before the photosensitive layer is applied. If the support layer 155 is inherently opaque, if desired, a window could be ground through the support layer in alignment with the photosensitive film pattern or the security device could be designed for viewing in reflected light. Additional security device components such as lens arrays can be applied to either side of the web in alignment with the photosensitive patterns P.

The so-formed web can then be subjected to any further processing steps necessary, such as the application of individual serial numbers or printing of personalisation data, before being cut into individual documents of value as indicated by the broken lines in FIG. 32(c). The result, as shown in FIG. 32(d), is a document of value integrally comprising a security device based on a patterned photosensitive film 2.

In all of the above embodiments, other security features such as holograms, kinegrams, magnetic features, luminescent or fluorescent substances and optically variable materials including inference layer structures and pigments can be incorporated into the security device component 9, or elsewhere, to further enhance the security level. Such additional features may or may not overlap the pattern carried by the photosensitive film provided the pattern remains at least partially visible such that the desired secure visual effect based on the pattern can still be observed.

1. A method of manufacturing a security device component, comprising:
providing a photosensitive film comprising a diazonium compound which decomposes upon exposure to radiation of a predetermined wavelength;
providing a dye coupler film comprising one or more dye coupler compositions;
exposing elements of the photosensitive film to radiation of the predetermined wavelength in accordance with a predetermined pattern;
contacting at least part of the exposed photosensitive film against at least part of the dye coupler film so as to effect at least partial transfer of the one or more dye coupler compositions to the exposed photosensitive film, whereupon unexposed elements of the photosensitive film exhibit one or more colours such that the photosensitive film exhibits a reproduction of the predetermined pattern.

2. A method according to claim 1, wherein contacting the exposed photosensitive film against the dye coupler film comprises applying a pressure urging the exposed photosensitive film against the dye coupler film, the pressure preferably being in the range 80 to 4000 grams/linear cm.

3. A method according to claim 1, further comprising heating the exposed photosensitive film and/or the dye coupler film during the contact between the films, preferably to a temperature in the range 75 to 140 degrees C., more preferably in the range 90 to 130 degrees C., most preferably around 100 degrees C.

4-5. (canceled)

6. A method according to claim 1, wherein the dye coupler film comprises a dye coupler carrier substrate on which the dye coupler composition is disposed, the dye coupler carrier substrate preferably being at least semi-transparent.

7. A method according to claim 6, further comprising forming the dye coupler film by applying the one or more dye coupler compositions to the dye coupler carrier substrate, preferably by printing or coating the one or more dye coupler compositions onto the dye coupler carrier substrate.

8. A method according to claim 7, further comprising drying the dye coupler film prior to contact between the dye coupler film and the exposed photosensitive film.

9. A method according to claim 6, wherein the steps of applying the one or more dye coupler compositions to the dye coupler carrier substrate and contacting the dye coupler film against the exposed photosensitive film are performed in a continuous, in-line process.

10. A method according to claim 6, wherein the steps of exposing the photosensitive film and contacting the dye coupler film against the exposed photosensitive film are performed in a continuous, in-line process

11. A method according to claim 1, further comprising separating the dye coupler film from the exposed photosensitive film after the at least partial transfer of dye coupler has taken place.

12. A method according to claim 1, wherein the dye coupler film comprises a first dye coupler composition in a first area of the dye coupler film and a second dye coupler composition, different from the first, in a second area of the dye coupler film which is different from the first area, such that, after contact between the dye coupler film and the exposed photosensitive film, unexposed elements of the photosensitive film in a first area exhibit a first colour and unexposed elements of the photosensitive film in a second area exhibit a second colour, the first and second areas of the photosensitive film corresponding to the first and second areas of the dye coupler layer, whereby the photosensitive film exhibits a multi-coloured reproduction of the predetermined pattern.

13. A method according to claim 1, wherein two or more dye coupler films are provided, of which a first dye coupler film comprises at least a first dye coupler composition and a second dye coupler film comprises at least a second dye coupler composition, and simultaneously or sequentially, a first area of the exposed photosensitive film is contacted with the first dye coupler film and a second area of the exposed photosensitive film is contacted with the second dye coupler film, such that unexposed elements of the photosensitive film in the first area exhibit a first colour and unexposed elements of the photosensitive film in the second area exhibit a second colour, whereby the photosensitive film exhibits a multi-coloured reproduction of the predetermined pattern.

14. A method of manufacturing a security device component, comprising:
providing a photosensitive film comprising a diazonium compound which decomposes upon exposure to radiation of a predetermined wavelength;
exposing elements of the photosensitive film to radiation of the predetermined wavelength in accordance with a predetermined pattern; then:
applying a first dye coupler composition to a first area of the photosensitive film, whereupon unexposed elements of the photosensitive film in the first area exhibit a first colour; and, simultaneously or sequentially:
applying a second dye coupler composition, different from the first, to a second area of the photosensitive film which is different from the first area, whereupon unexposed elements of the photosensitive film in the second area exhibit a second colour, different from the first colour;
such that the photosensitive film exhibits a multi-coloured reproduction of the predetermined pattern.

15. A method according to claim 14, wherein the first and second dye coupler compositions are applied to the photosensitive film in register with one another.

16. A method according to claim 14, wherein the first and second dye coupler compositions are applied to the photosensitive film by one of:
(a) printing or coating each dye coupler composition onto the photosensitive film;
(b) providing a dye coupler film comprising a first dye coupler composition in a first area of the dye coupler film and a second dye coupler composition, different from the first, in a second area of the dye coupler film which is different from the first area, the first and second areas of the dye coupler layer corresponding to the first and second areas of the photosensitive film; and
(c) providing a first dye coupler film comprising a first dye coupler composition and a second dye coupler film comprising a second dye coupler composition, different from the first; and
contacting the first area of the exposed photosensitive film against the first dye coupler film and the second area of the exposed photosensitive film against the second dye coupler film so as to effect at least partial transfer of the first and second dye coupler compositions to the respective areas of the exposed photosensitive film.

17-19. (canceled)

20. A method according to claim 13, wherein the first and second areas are laterally offset from one another.

21. A method according to claim 13, wherein the first and second areas fully overlap one another, the first area being located wholly within the second area or vice versa, whereby one of the first and second colours results from the first and second dye coupler compositions in combination, or the first and second areas partially overlap one another, the unexposed elements of the photosensitive film in the area of overlap exhibiting a further colour resulting from the first and second dye coupler compositions in combination.

22. (canceled)

23. A method according to claim 13, further comprising applying a third and optionally further dye coupler compositions, each different from the first and second dye coupler compositions, to a respective area of the photosensitive film which is different from the first and second areas, whereupon unexposed elements of the photosensitive film in each respective area exhibit a different colour.

24. A method according to claim 13, wherein each area encompasses a plurality of the unexposed pattern elements.

25. (canceled)

26. A method according to claim 13, wherein the areas define a second predetermined pattern, preferably defining images, symbols or alphanumeric characters or a pattern of stripes, lines or tessellating shapes, most preferably fine-line patterns, filigree or guilloche patterns.

27. (canceled)

28. A method according to claim 13, wherein the method is a web-based, continuous production method, comprising conveying the photosensitive film along a transport path, and wherein the areas are laterally offset from one another in the direction parallel to the transport path and/or in the direction perpendicular to the transport path.

29-32. (canceled)

33. A method according to claim 1 wherein the photosensitive film is disposed on a photosensitive film carrier substrate, the photosensitive film carrier substrate preferably being substantially transparent in the visible spectrum.

34-35. (canceled)

36. A method according to claim 33, further comprising applying the photosensitive film to the photosensitive film carrier substrate, preferably by printing or coating.

37-41. (canceled)

42. A method according to claim 1, wherein the predetermined pattern according to which the photosensitive film is exposed is configured to exhibit a secure visual effect, preferably an optically variable effect, alone or in combination with a viewing component such as a second pattern component, a focussing element or array of focussing elements.

43. A method according to claim 1, wherein the photosensitive film is disposed on a photosensitive film carrier substrate further comprising one or more focussing elements, or the method further comprises arranging one or more focussing elements to overlap the photosensitive film, the photosensitive film lying substantially in the focal plane of the focussing element(s), whereby a substantially focussed image of at least part of the predetermined pattern is generated.

44-46. (canceled)

47. A method according to claim 1, wherein the exposed photosensitive film forms all or part of a security article for application onto or incorporation into an object of value, preferably a document of value, the security article preferably taking the form of a thread, strip or band.

48-50. (canceled)

51. A method according to claim 1, wherein the photosensitive film is provided on a photosensitive film carrier substrate and a release layer is disposed between the photosensitive film and the carrier substrate, portions of at least the exposed photosensitive film constituting security articles, the security articles preferably taking the form of labels or transfer foils.

52-53. (canceled)

54. A method according to claim 47, further comprising applying the security article to or incorporating the security article into an object, preferably a document of value, the object comprising a viewing component aligned with at least part of the reproduction of the predetermined pattern, whereby the viewing component and the predetermined pattern in combination exhibit a secure visual effect.

55. A method according to claim 1, wherein the photosensitive film is provided on a photosensitive film carrier substrate constituting one or more objects of value, preferably documents of value, and the method preferably further comprises cutting the photosensitive film carrier substrate into individual objects, each object displaying at least part of the reproduction of the predetermined pattern.

56. A method according to claim 55, wherein the photosensitive film carrier substrate is printed or coated before or after exposing the photosensitive film, the printing or coating defining a window which is at least semi-transparent in the visible spectrum, and the window containing region(s) of the photosensitive film which have been or will be exposed, such that at least part of the reproduction of the predetermined pattern is displayed in the window.

57. A security device component made in accordance with claim 1.

58. A security device component comprising an exposed photosensitive film exhibiting a multi-coloured pattern of elements, the elements in a first area of the photosensitive film comprising a first azo dye exhibiting a first colour, and the elements in a second areas of the photosensitive film comprising a second azo dye, different from the first, exhibiting a second colour.

59. A security device component according to claim 58, wherein the first and second areas are laterally offset from one another.

60. A security device component according to claim 58, wherein either the first and second areas fully overlap one another, the first area being located wholly within the second area or vice versa or the first and second areas partially overlap one another, elements of the photosensitive film in the area of overlap exhibiting a further colour.

61. (canceled)

62. A security device component according to claim 58, wherein elements of the pattern in third and optionally further areas of the photosensitive film exhibit further different colours respectively.

63. A security device component according to claim 58, wherein each area encompasses a plurality of the pattern elements.

64. A security device component according to claim 58, wherein each area has dimensions of at least 100 microns, preferably at least 0.5 mm, more preferably at least 1 mm, in at least one direction, preferably in two orthogonal directions.

65. A security device component according to claim 58, wherein the areas define a second pattern, preferably defining images, symbols or alphanumeric characters or a pattern of stripes, lines or tessellating shapes, most preferably fine-line patterns, filigree or guilloche patterns.

66. (canceled)

67. A security device comprising a security device component in accordance with claim 58.

68. A security device according to claim 67 further comprising a layer having a second pattern of elements overlapping the pattern exhibited by the photosensitive film, to form in combination a venetian blind device or a moiré interference device, having an appearance which differs at different viewing angles.

69. A security device according to claim 67, further comprising one or more focussing elements defining a focal plane, the pattern exhibited by the photosensitive film being substantially coincident with the focal plane, whereby a focussed image of at least a portion of the pattern is generated.

70-71. (canceled)

72. A security article comprising a security device component according to claim 58 the security article preferably being a thread, a strip, a foil, a patch, a transfer, a label or an insert.

73. An object of value comprising a security device component according to claim 58, the object of value preferably being a document of value such as a banknote, a cheque, a passport, a visa, a tax disc, an ID card, a certificate, a stamp, a ticket, a share certificate, a drivers' license, or a certificate of guarantee.
